(19) United States
(12) Patent Application Publication
(10) Pub. No.: US 2026/0044105 A1
(43) Pub. Date: Feb. 12, 2026

(54) SHEET CONVEYING DEVICE, SHEET PROCESSING APPARATUS, AND IMAGE FORMING APPARATUS

(71) Applicants: Shuuto TOHKAISHI, Kanagawa (JP); Yuusuke SHIBASAKI, Kanagawa (JP); Atsushi SHINODA, Kanagawa (JP); Sho ASANO, Kanagawa (JP); Wataru TAKAHASHI, Kanagawa (JP); Tomomichi HOSHINO, Kanagawa (JP); Kotomi KAMEYAMA, Kanagawa (JP); Satoshi HIRATA, Kanagawa (JP); Shingo YOSHIZAWA, Kanagawa (JP); Suzuka FUJITA, Kanagawa (JP); Naofumi YOSHIDA, Kanagawa (JP); Naohiro YOSHIDA, Kanagawa (JP); Ryota TAKAYAMA, Kanagawa (JP); Hirotaka YASUKAWA, Kanagawa (JP); Yoshito SUZUKI, Kanagawa (JP); Shinya MONMA, Kanagawa (JP); Yuji SUZUKI, Kanagawa (JP); Wataru NOZAKI, Kanagawa (JP); Jun YAMADA, Kanagawa (JP); Yohsuke HARAGUCHI, Kanagawa (JP); Yusuke HIRONO, Kanagawa (JP); Takahiro WATANABE, Kanagawa (JP)

(72) Inventors: Shuuto TOHKAISHI, Kanagawa (JP); Yuusuke SHIBASAKI, Kanagawa (JP); Atsushi SHINODA, Kanagawa (JP); Sho ASANO, Kanagawa (JP); Wataru TAKAHASHI, Kanagawa (JP); Tomomichi HOSHINO, Kanagawa (JP); Kotomi KAMEYAMA, Kanagawa (JP); Satoshi HIRATA, Kanagawa (JP); Shingo YOSHIZAWA, Kanagawa (JP); Suzuka FUJITA, Kanagawa (JP); Naofumi YOSHIDA, Kanagawa (JP); Naohiro YOSHIDA, Kanagawa (JP); Ryota TAKAYAMA, Kanagawa (JP); Hirotaka YASUKAWA, Kanagawa (JP); Yoshito SUZUKI, Kanagawa (JP); Shinya MONMA, Kanagawa (JP); Yuji SUZUKI, Kanagawa (JP); Wataru NOZAKI, Kanagawa (JP); Jun YAMADA, Kanagawa (JP); Yohsuke HARAGUCHI, Kanagawa (JP); Yusuke HIRONO, Kanagawa (JP); Takahiro WATANABE, Kanagawa (JP)

(21) Appl. No.: 19/280,199

(22) Filed: Jul. 25, 2025

(30) Foreign Application Priority Data
Aug. 6, 2024 (JP) 2024-129859

(51) Int. Cl. G03G 15/00

(52) U.S. Cl. CPC G03G 15/6573; G03G 15/5016; G03G 15/6544; G03G 15/6552

(57) ABSTRACT

A sheet conveying device includes a shift roller pair, a shifter, multiple roller shafts, and a coupler. The shift roller pair includes first shift rollers, and second shift rollers facing the first shift rollers. The shift roller pair is conveyable a sheet in a sheet conveyance direction and movable in a width direction orthogonal to the sheet conveyance direction. The shifter moves the shift roller pair in the width direction to shift the sheet in the width direction as a shift operation. The multiple roller shafts support the first shift rollers. The coupler couples the multiple roller shafts and is rotatable with respect to the multiple roller shafts.

### CROSS-REFERENCE TO RELATED APPLICATION

This patent application is based on and claims priority pursuant to 35 U.S.C. § 119(a) to Japanese Patent Application No. 2024-129859, filed on Aug. 6, 2024, in the Japan Patent Office, the entire disclosure of which is hereby incorporated by reference herein.

### BACKGROUND

### Technical Field

Embodiments of the present disclosure relate to a sheet conveying device, a sheet processing apparatus, and an image forming apparatus.

### Related Art

Sheet conveying devices are known that include a conveyance roller pair to convey a sheet or sheets.

A sheet conveying device in the art includes a shift roller pair and a shift unit. The shift roller pair is movable in a width direction that is perpendicular to a sheet conveyance direction. The shift unit performs a shift operation in which the sheet is moved in the width direction by the shift roller pair to shift the sheet when conveying the sheet by the shift roller pair.

### SUMMARY

Embodiments of the present disclosure described herein provide a novel sheet conveying device including a shift roller pair, a shifter, multiple roller shafts, and a coupler. The shift roller pair includes first shift rollers, and second shift rollers facing the first shift rollers. The shift roller pair is conveyable a sheet in a conveyance direction and movable in a width direction orthogonal to the sheet conveyance direction. The shifter moves the shift roller pair in the width direction to shift the sheet in the width direction as a shift operation. The multiple roller shafts support the first shift rollers. The coupler couples the multiple roller shafts and is rotatable with respect to the multiple roller shafts.

Further, embodiments of the present disclosure described herein provide a sheet processing apparatus including the above-described sheet conveying device, and a sheet processing device to perform a given process on a sheet conveyed by the sheet conveying device.

Further, embodiments of the present disclosure described herein provide a sheet processing apparatus including a sheet processing device to perform a given process on a sheet, and the above-described sheet conveying device to convey the sheet on which the given process is performed by the sheet processing device.

Further, embodiments of the present disclosure described herein provide an image forming apparatus including an image forming device to form an image on a sheet, and the above-described sheet conveying device to convey the sheet on which the image is formed by the image forming device.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIGS. 1A and 1B are diagrams each illustrating an example of a configuration of an image forming system;

FIG. 2A is a diagram illustrating an example of a structure of an image forming system;

FIG. 2B is a diagram illustrating an example of a functional block of the image forming system of FIG. 2A;

FIG. 3A is a diagram illustrating an example of a structure of an image forming system;

FIG. 3B is a diagram illustrating an example of a functional block of the image forming system of FIG. 3A;

FIG. 4 is a diagram illustrating of a hardware configuration of an electrical component unit of the image forming system;

FIG. 5 is a diagram illustrating a conveyance path of an inner finisher;

FIG. 6 is a diagram illustrating an operation of an inner finisher;

FIG. 7A is a diagram illustrating a sheet binder;

FIG. 7B is a diagram illustrating an operation of an inner finisher, subsequent to the operation of the inner finisher of FIG. 7A;

FIG. 8 is a diagram illustrating an operation of an inner finisher, subsequent to the operation of the inner finisher of FIG. 7B;

FIG. 9 is a diagram illustrating an operation of an inner finisher, subsequent to the operation of the inner finisher of FIG. 8;

FIG. 10 is a schematic diagram illustrating a shift roller pair according to the present embodiment;

FIG. 11 is a plan view of a shift roller pair according to the present embodiment;

FIG. 12 is a schematic diagram illustrating a shift roller pair shifted by a shifting mechanism;

FIG. 13 is a schematic diagram illustrating a shift roller pair according to a related art;

FIG. 14 is a graph of a pressure force applied to a sheet by each conveyance roller pair of a shift roller pair according to a related art;

FIG. 15 is a diagram illustrating an example of sheet conveyance by a shift roller pair according to a related art;

FIG. 16 is a diagram illustrating an example of sheet conveyance by a shift roller pair according to a related art;

FIG. 17A is a schematic diagram illustrating a shift roller pair according to a related art shifted to the rear side of an inner finisher;

FIG. 17B is a graph of a pressure force applied to a sheet by each conveyance roller pair of a shift roller pair according to a related art when shifted to the rear side of the inner finisher of FIG. 17A;

FIG. 18A is a schematic diagram illustrating a shift roller pair according to a related art shifted to the front side of an inner finisher;

FIG. 18B is a graph of a pressure force applied to a sheet by each conveyance roller pair of a shift roller pair according to a related art when shifted to the at the front side of the inner finisher of FIG. 18A;

FIG. 19A is a diagram illustrating a shift roller pair according to the present embodiment located at a default position;

FIG. 19B is a graph of a pressure force applied to a sheet by each conveyance roller pair at the default position;

FIG. 20 is a diagram illustrating an example of sheet conveyance by a shift roller pair according to the present embodiment;

FIG. 21 is a diagram illustrating an example of sheet conveyance by a shift roller pair according to the present embodiment;

FIGS. 22A and 22B are diagrams each illustrating an example of a configuration in which the rotation of a coupling member is not restricted during a shift operation;

FIGS. 23A and 23B are schematic diagrams each illustrating a shift driven roller in which a first driven roller shaft and a second driven roller shaft are coupled by a coupling member according to the present embodiment;

FIGS. 24A and 24B are diagrams each illustrating a relation of dimension of a coupling member and a driven roller shaft, according to the present embodiment;

FIG. 25A is a diagram illustrating restriction of rotation of a coupling member when a shift roller pair is shifted to the rear side of an inner finisher;

FIG. 25B is a diagram illustrating restriction of rotation of a coupling member when a shift roller pair is shifted to the front side of an inner finisher;

FIG. 26A is a schematic diagram illustrating a shift roller pair according to the present embodiment when shifted to the rear side of an inner finisher;

FIG. 26B is a graph of a pressure force applied to a sheet by each conveyance roller pair of a shift roller pair according to the present embodiment when shifted to the rear side of the inner finisher of FIG. 26A;

FIG. 27A is a schematic diagram illustrating a shift roller pair according to the present embodiment when shifted to the front side of an inner finisher;

FIG. 27B is a graph of a pressure force applied to a sheet by each conveyance roller pair of a shift roller pair according to the present embodiment when shifted to the front side of the inner finisher of FIG. 27A;

FIGS. 28A and 28B are schematic diagrams each illustrating a shift roller pair according to a first modification;

FIG. 29 is a diagram illustrating a relation of a dimension of a shift roller pair according to the first modification;

FIG. 30A is a diagram illustrating restriction of rotation of a coupling member when a shift roller pair is shifted to the rear side of an inner finisher, according to the first modification;

FIG. 30B is a diagram illustrating restriction of rotation of a coupling member when a shift roller pair is shifted to the front side of an inner finisher, according to the first modification;

FIGS. 31A and 31B are schematic diagrams each illustrating a shift roller pair according to a second modification;

FIG. 32 is a diagram illustrating a relation of a dimension of a shift roller pair according to the second modification;

FIG. 33A is a diagram illustrating restriction of rotation of a coupling member when a shift roller pair is shifted to the rear side of an inner finisher, according to the second modification;

FIG. 33B is a diagram illustrating restriction of rotation of a coupling member when a shift roller pair is shifted to the front side of an inner finisher, according to the second modification;

FIG. 34A is a schematic diagram illustrating an example of a coupling member disposed between a first conveyance roller pair and a second conveyance roller adjacent to the first conveyance roller pair on the rear side of an inner finisher;

FIG. 34B is a graph of a pressure force applied to a sheet by each conveyance roller pair of a shift roller pair in the example of FIG. 34A;

FIG. 35A is a schematic diagram illustrating an example of a coupling member disposed between a first conveyance roller pair and a second conveyance roller adjacent to the first conveyance roller pair on the front side of an inner finisher;

FIG. 35B is a graph of a pressure force applied to a sheet by each conveyance roller pair of a shift roller pair in the example of FIG. 35A;

FIG. 36A is a schematic diagram illustrating an example of a shift driven roller that includes three driven roller shafts; and

FIG. 36B is a graph of a pressure force applied to a sheet by each conveyance roller pair of a shift roller pair in the example of FIG. 36A.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

A description is given of an image forming system including an image forming apparatus and a post-processing apparatus, according to an embodiment of the present disclosure.

First, a description is given of an overall configuration of an image forming system.

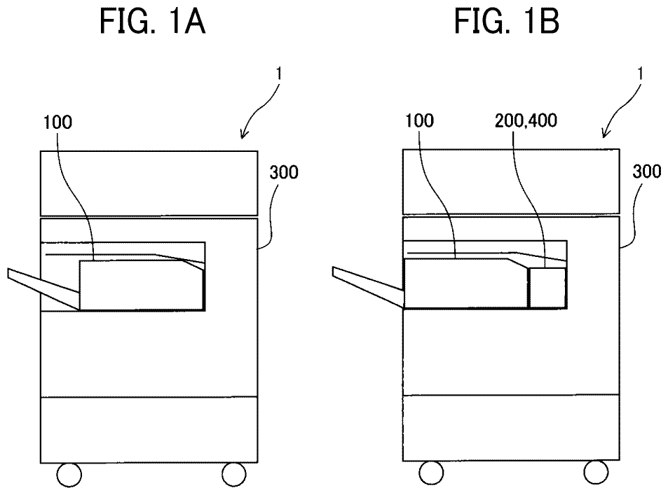

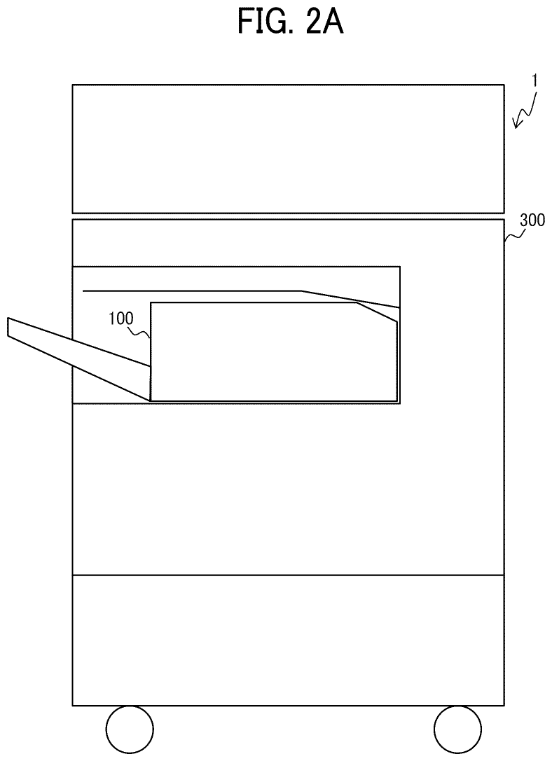

FIGS. 1A and 1B are diagrams each illustrating an example of a configuration of an image forming system 1 including an inner finisher 100 as a post-processing apparatus and an image forming apparatus 300.

The inner finisher 100 includes a post-processing apparatus disposed in an in-body part of an image forming apparatus in order to prevent an increase of the installation area for the inner finisher 100. The inner finisher 100 may be applied to a coupling embodiment with a post-processing apparatus disposed outside the image forming apparatus 300.

FIG. 1A is an example of the configuration of the image forming system 1 in which the image forming apparatus 300 and the inner finisher 100 are coupled to each other.

In the image forming system 1, a paper (sheet) on which an image is formed by the image forming apparatus 300 is received by the inner finisher 100 to perform post-processing such as sheet binding.

FIG. 1B is an example of the configuration of the image forming system 1 in which the image forming apparatus 300, an inner finisher option device 200, and the inner finisher 100 are coupled to each other.

After the image forming apparatus 300 forms an image on a sheet, the inner finisher option device 200 performs, for example, a punching operation on the sheet, and the inner finisher 100 receives the sheet to perform post-processing such as sheet binding. The inner finisher option device 200 is an optional device with which the user can determine whether to install or not, and purchase.

Instead of or in addition to the inner finisher option device 200 that performs an operation such as the punching process, an inner finisher option device 400 that performs, for example, a folding process can be coupled to the image forming apparatus 300. The inner finisher option device 200 and the inner finisher option device 400 are optional devices that are detachably attachable to the image forming apparatus 300. The interface (I/F) portions of the inner finisher option device 200 and the inner finisher option device 400 are detachably attachable to the image forming apparatus 300 in a mechanical manner, for example, by a relay connector or a drawer connector.

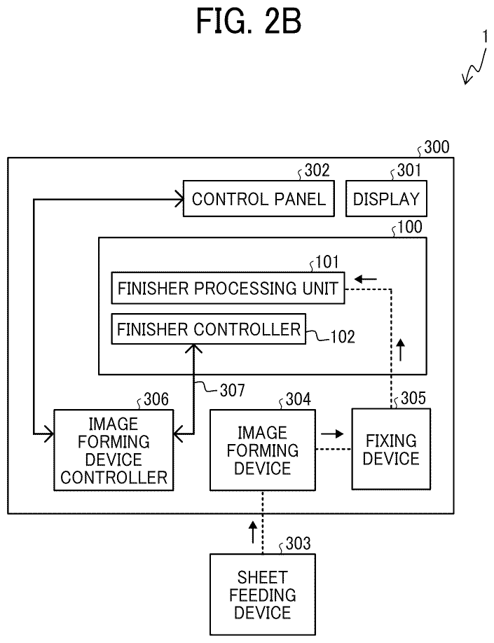

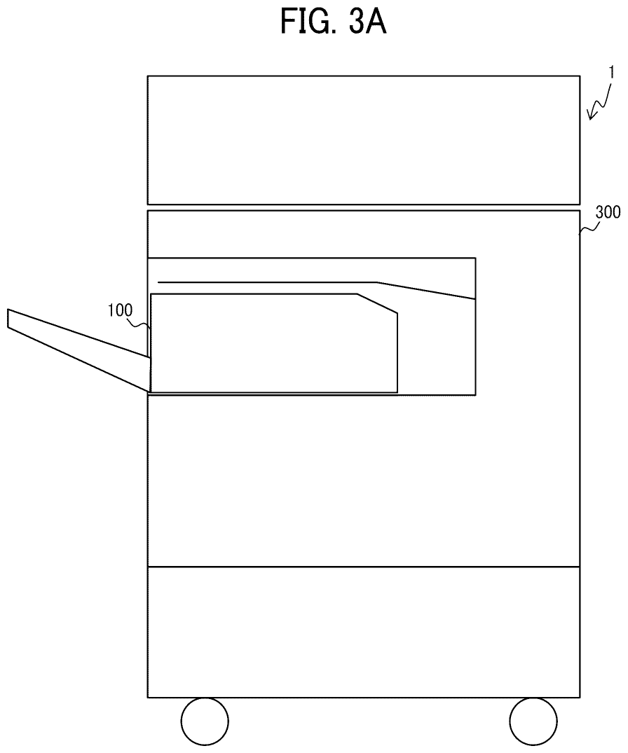

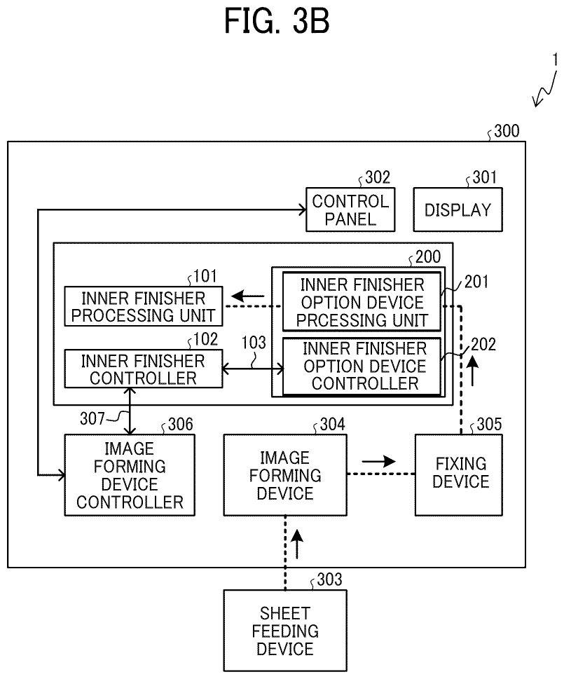

FIGS. 2A, 2B, 3A and 3B are diagrams each illustrating a functional block of the image forming system 1.

FIG. 2A is a diagram illustrating an example of a structure of the image forming system 1 when an inner finisher option device is not installed.

FIG. 2B is a diagram illustrating an example of a functional block of the image forming system 1 of FIG. 2A.

In each of FIGS. 2A and 2B, the flow of communication signals is indicated by solid lines and the flow of sheets is indicated by broken lines. The image forming apparatus 300 is an apparatus that forms an image on a sheet by a known electrophotographic process. The image forming apparatus 300 includes a display 301 and a control panel 302. The display 301 outputs a notification to inform the state of various components and the operation contents to the user. The control panel 302 allows the user to set, for example, an operation mode and the number of copies. The image forming apparatus 300 further includes a sheet feeding device 303 and an image forming device 304. The sheet feeding device 303 contains sheets to separate and convey the sheets one by one. The image forming device 304 forms a latent image on a photoconductor to transfer the image onto a sheet. The image forming apparatus 300 further includes a fixing device 305 and an image forming device controller 306. The fixing device 305 fixes the image transferred on the sheet. The image forming device controller 306 controls various blocks.

The inner finisher 100 instructs an operation to the inner finisher controller 102 from the image forming device controller 306 of the image forming apparatus 300 via a communication line 307, so that the inner finisher controller 102 executes the designated operation on a sheet designated by an inner finisher processing unit 101. The image forming device controller 306 and the inner finisher controller 102 are connected to each other via the communication line 307 to exchange information between the image forming device controller 306 and the inner finisher controller 102. By so doing, information related to operation modes and information on, for example, the sheet size and the timing are exchanged to make the system operable.

FIG. 3A is a diagram illustrating an example of a structure of the image forming system 1 when an inner finisher option device is installed.

FIG. 3B is a diagram illustrating an example of a functional block of the image forming system 1 of FIG. 3A.

In the inner finisher option device 200, an instruction is sent from the inner finisher controller 102 to an inner finisher option device controller 202 via a communication line 103, so that the inner finisher option device controller 202 executes the designated operation on a sheet designated by an inner finisher option device processing unit 201. The other parts and components of the functional block in FIG. 3B are the same as the parts and components of the functional block in FIG. 2B.

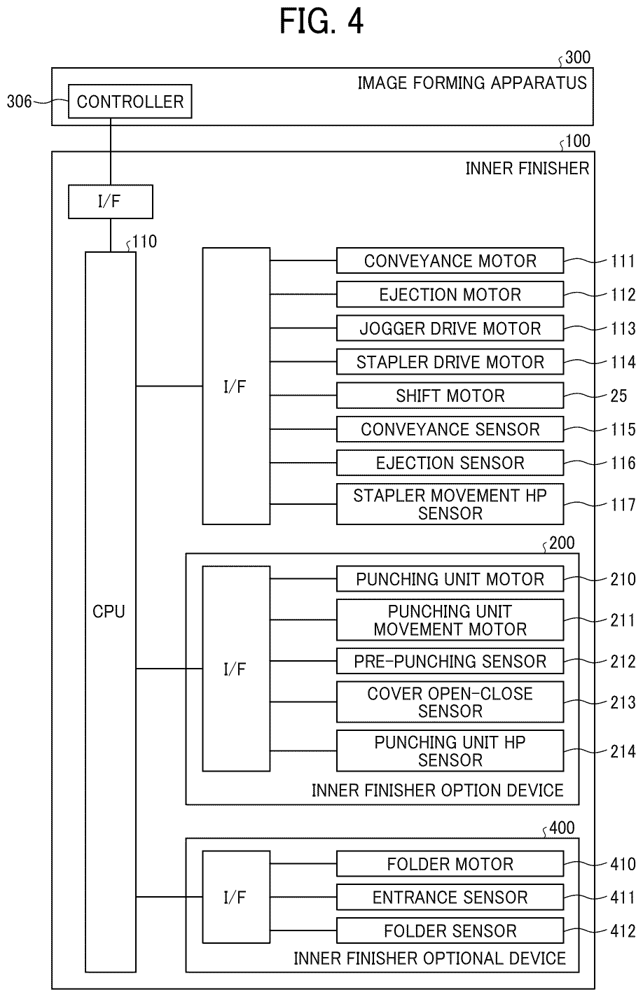

FIG. 4 is a diagram illustrating of a hardware configuration of the electrical component unit of the image forming system 1.

As illustrated in FIG. 4, the inner finisher 100 includes a central processing unit (CPU) 110. The CPU 110 is connected to various motors and various sensors via an interface (I/F). The CPU 110 is an arithmetic unit and controls the entire operation of the inner finisher 100.

The various motors include a conveyance motor 111, a sheet ejection motor 112, a jogger drive motor 113, a stapler drive motor 114, and a shift motor 25. The various sensors include a conveyance sensor 115, a sheet ejection sensor 116, and a stapler movement home position (HP) sensor 117.

The inner finisher option device 200 and the inner finisher option device 400, which are option devices of the inner finisher 100, are connected to the CPU 110 of the inner finisher 100 via an interface (I/F). The inner finisher option device 200 and the inner finisher option device 400 control the operations by the CPU 110 of the inner finisher 100.

The inner finisher option device 200 includes a punching unit motor 210, a punching unit movement motor 211, a pre-punching sensor 212, a cover open-close sensor 213, and a punching unit home position (HP) sensor 214. The inner finisher option device 400 includes a folder motor 410, an entrance sensor 411, and a folder sensor 412.

The CPU 110 in the inner finisher 100 is connected to the image forming device controller 306 in the image forming apparatus 300 via an interface (I/F) to control the inner finisher 100 according to a processing signal from the image forming apparatus 300. Since the inner finisher 100 is an optional device that is similar to the inner finisher option device 200 and the inner finisher option device 400, the inner finisher 100 has a mechanical configuration that is detachably attachable to the image forming apparatus 300.

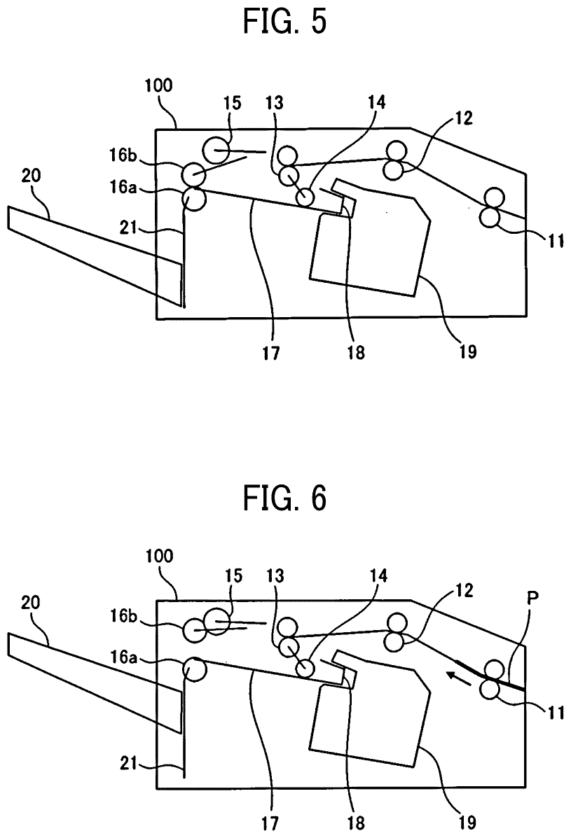

FIG. 5 is a diagram illustrating a conveyance path of the inner finisher 100. An entrance roller pair 11 is a most upstream conveyance roller pair of the inner finisher 100.

A conveyance roller pair 12 is a second conveyance roller pair of the inner finisher 100. A shift roller pair 13 is a conveyance roller pair to shift a sheet in the width direction of the inner finisher 100. A return roller 14 is a roller to convey and contact the sheet to the reference fence 18. A tapping roller 15 is a roller to convey the sheet toward the reference fence 18. An ejection roller 16a is a most downstream conveyance roller of the inner finisher 100. A staple tray 17 is a tray to temporarily stack (place) a sheet or sheets for sheet binding, and corresponds to a sheet stacker to stack sheets. The reference fence 18 is a fence to which the trailing end of the sheet or sheets contacts for aligning the conveyance direction of the sheets when binding the sheets, and corresponds to a contact member. A stapler 19 is a device to perform a sheet binding operation. A sheet ejection tray 20 is a tray to which a sheet or a sheet bundle is ejected. An end fence 21 is a fence to which the trailing end of the ejected sheet or sheets contacts for aligning the sheets.

The inner finisher 100 has a mode in which a sheet is conveyed and ejected to the sheet ejection tray 20 (shift sheet ejection mode), and a mode in which a sheet is stapled by the stapler 19 (staple mode). In the shift sheet ejection mode, a sheet that is conveyed from the image forming apparatus 300 is received by the entrance roller pair 11, conveyed to the ejection roller 16a, and ejected to the sheet ejection tray 20.

In the staple mode, a sheet that is conveyed from the image forming apparatus 300 is received by the entrance roller pair 11, conveyed to the shift roller pair 13, conveyed by switchback conveyance by the tapping roller 15 and the return roller 14 on the staple tray 17, and ejected to the reference fence 18. This operation is repeated until the number of sheets reaches a given number of sheets. Then, when the last sheet is conveyed to the reference fence 18, the staples are driven into the sheet bundle by the stapler 19 to bind the sheet bundle, and the sheet bundle is ejected by the return roller 14 and the ejection roller 16a to the sheet ejection tray 20.

FIGS. 6, 7A, 7B, 8 and 9 are diagrams of the inner finisher 100 for explaining the movements of a sheet P in the shift sheet ejection mode.

In FIG. 6, the sheet P conveyed from the image forming apparatus 300 is conveyed and received in the inner finisher 100.

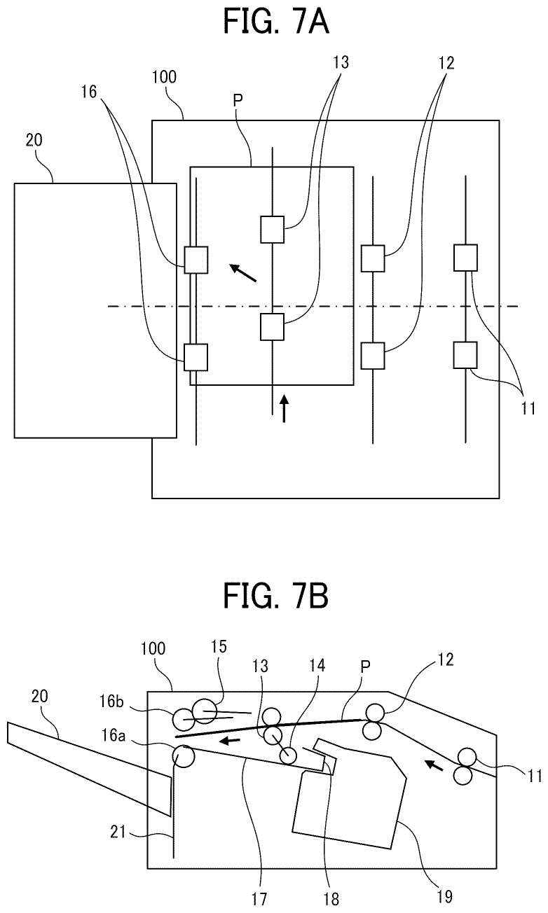

In FIGS. 7A and 7B, the shift roller pair 13 is moved in the width direction of the sheet P, and the sheet P is conveyed while being shifted in the width direction by the shift roller pair 13.

In FIGS. 7A and 7B, an ejection driven roller 16b remains at a pressure releasing position.

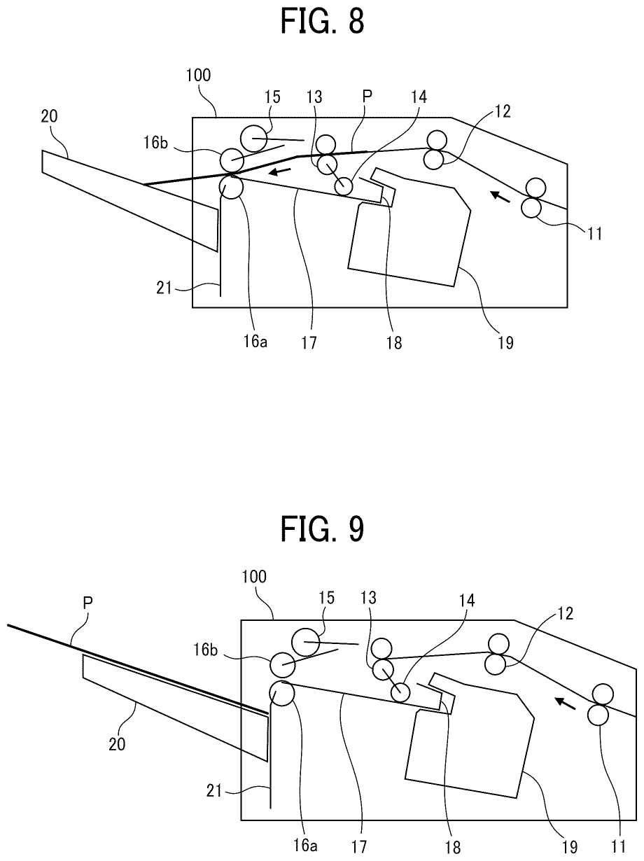

In FIG. 8, after the sheet P passes through the shift roller pair 13, the ejection driven roller 16b is moved from the pressure releasing position to the nip position, and the sheet P is ejected onto the sheet ejection tray 20 by the ejection roller 16a.

In FIG. 9, the sheet P is ejected on the sheet ejection tray 20.

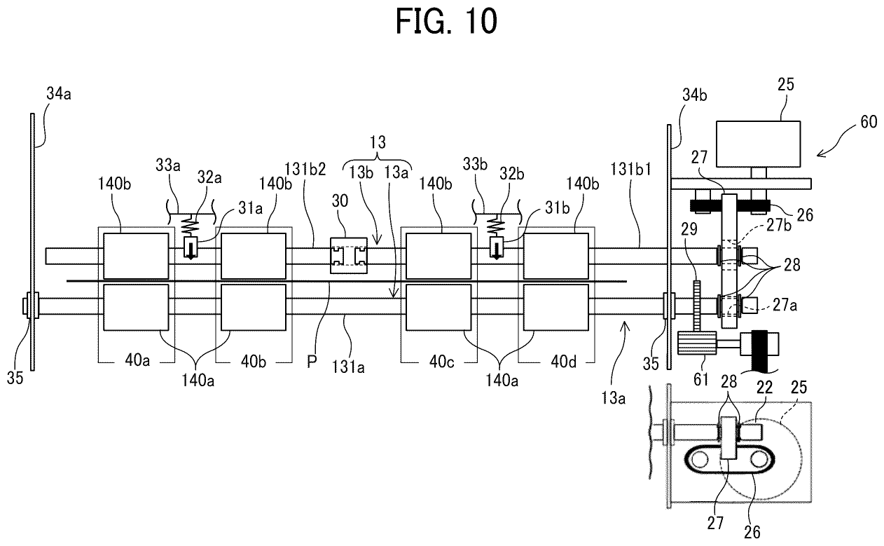

FIG. 10 is a schematic diagram illustrating the shift roller pair 13 according to the present embodiment, viewed from the downstream side in the sheet conveyance direction.

FIG. 11 is a plan view of the shift roller pair 13 according to the present embodiment.

The shift roller pair 13 includes a shift drive roller 13a and a shift driven roller 13b. The shift drive roller 13a includes a drive roller shaft 131a and four drive conveyance rollers 140a supported by the drive roller shaft 131a. The four drive conveyance rollers 140a are disposed at given intervals in an axial direction (the width direction of a sheet P) and are supported by the drive roller shaft 131a so as to integrally rotate with the drive roller shaft 131a. The drive roller shaft 131a is rotatably supported by a rear side panel 34a and a front side panel 34b of the inner finisher 100 via the bearings 35 in the shaft direction (the width direction of a sheet P).

The shift driven roller 13b includes a first driven roller shaft 131b1 and a second driven roller shaft 131b2. The first driven roller shaft 131b1 and the second driven roller shaft 131b2 are coupled by a coupling member 30 at the center in the axial direction. Two driven conveyance rollers 140b are mounted at a given interval in the axial direction on each of the first driven roller shaft 131b1 and the second driven roller shaft 131b2. Multiple driven conveyance rollers 140b are pressed in and fixed to the first driven roller shaft 131b1 and the second driven roller shaft 131b2, and are supported by the first driven roller shaft 131b1 and the second driven roller shaft 131b2 so as to integrally rotate with the first driven roller shaft 131b1 and the second driven roller shaft 131b.

Multiple driven conveyance rollers 140b contact multiple drive conveyance rollers 140a of the shift drive roller 13a facing the multiple driven conveyance rollers 140b and form four conveyance roller pairs 40a, 40b, 40c and 40d.

Further, a space between the two driven conveyance rollers 140b supported by the first driven roller shaft 131b1 and a space between the two driven conveyance rollers 140b supported by the second driven roller shaft 131b2 are biased toward the shift drive roller 13a by the pressing members 32a and 32b. The pressing members 32a and 32b are springs. One end of each of the pressing members 32a and 32b is fixed to one of the pressing fixed member 33a and 33b, respectively. The other of each of the pressing members 32a and 32b is fixed to one of the pressure receiving members 31a and 31b, respectively. The pressure receiving member 31a is in contact with the outer peripheral face of the driven roller shafts 131b2. The pressure receiving member 31b is in contact with the outer peripheral face of the driven roller shafts 131b1.

A shift mechanism 60 that functions as a shift unit is disposed on the front side of the inner finisher 100 to move the shift roller pair 13 in the axial direction (the width direction of a sheet P).

The shift mechanism 60 includes a shift motor 25. A pulley is disposed at the tip of the motor shaft of the shift motor 25. A timing belt 26 is stretched around the pulley of the shift motor 25 and a pulley disposed at a given interval apart from the pulley of the shift motor 25 in the axial direction. A movable member 27 is fixed to the timing belt 26.

The movable member 27 has a first through-hole 27a through which the drive roller shaft 131a passes and a second through-hole 27b through which the first driven roller shaft 131b1 passes. The first through-hole 27a has a round hole shape with a diameter greater than the diameter of the drive roller shaft 131a. The drive roller shaft 131a is rotatable with respect to the movable member 27. The second through-hole 27b has a slot shape extending in the vertical direction (the direction orthogonal to both the sheet conveyance direction and the width direction). Further, the length of the second through-hole 27b in the lateral direction is greater than the diameter of the first driven roller shaft 131b1. The first driven roller shaft 131b1 is rotatable with respect to the movable member 27.

Grooves are formed on both sides of the drive roller shaft 131a and the first driven roller shaft 131b1 across the movable member 27. Restrictors 28 are fitted into the grooves.

An output gear 29 is attached to the end portion on the front side of the drive roller shaft 131a so that the output gear 29 integrally rotates with the drive roller shaft 131a. The output gear 29 meshes with a wide gear 61 of a drive transmitter that transmits a driving force of the conveyance motor 111 to the shift drive roller 13a. The wide gear 61 is longer than the output gear 29 in the axial direction, and can maintain the meshing with the output gear 29 even when the shift drive roller 13a moves in the axial direction.

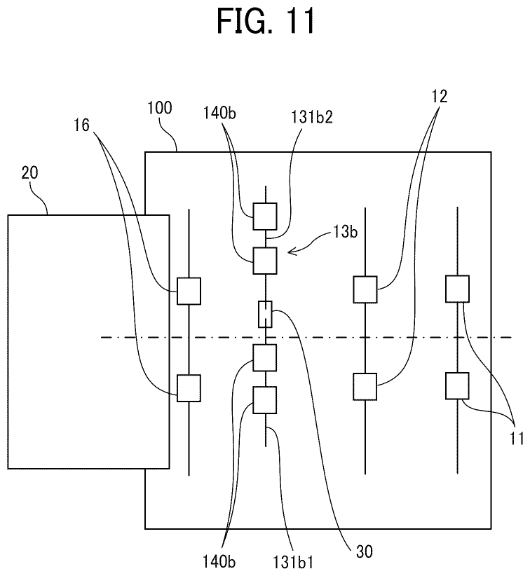

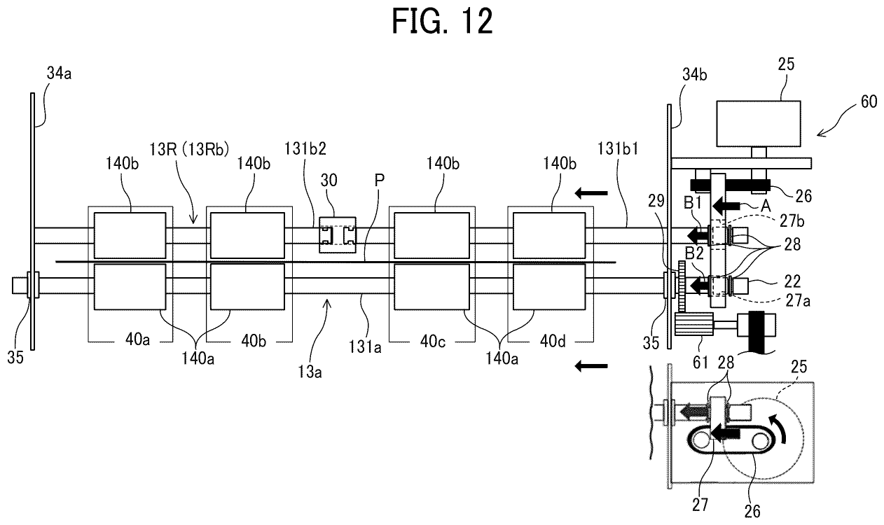

FIG. 12 is a schematic diagram illustrating the shift roller pair 13 shifted by the shift mechanism 60.

As the shift motor 25 is driven to rotate, the timing belt 26 rotates, and the movable member 27 fixed to the timing belt 26 moves to the rear side as indicated by arrow A in FIG. 12. Due to this movement of the movable member 27, the movable member 27 contacts the restrictor 28 on the rear side and moves to the rear side with the restrictor 28 on the rear side. Then, the restrictor 28 on the rear side contacts the side face of the groove into which the restrictor 28 on the rear side is fitted, so that the first driven roller shaft 131b1 is pushed to the rear side and the shift driven roller 13b shifts to the rear side (as indicated by arrow B in FIG. 12). Similarly, due to the movement of the movable member 27, the drive roller shaft 131a is pushed to the rear side via the restrictor 28 on the rear side, so that the shift drive roller 13a shifts to the rear side (as indicated by arrow B in FIG. 12). By rotating the shift motor 25 in the reverse direction, the movable member 27 pushes the first driven roller shaft 131b1 and the drive roller shaft 131a toward the front side via the restrictor 28 on the front side, and the shift roller pair 13 is shifted toward the front side.

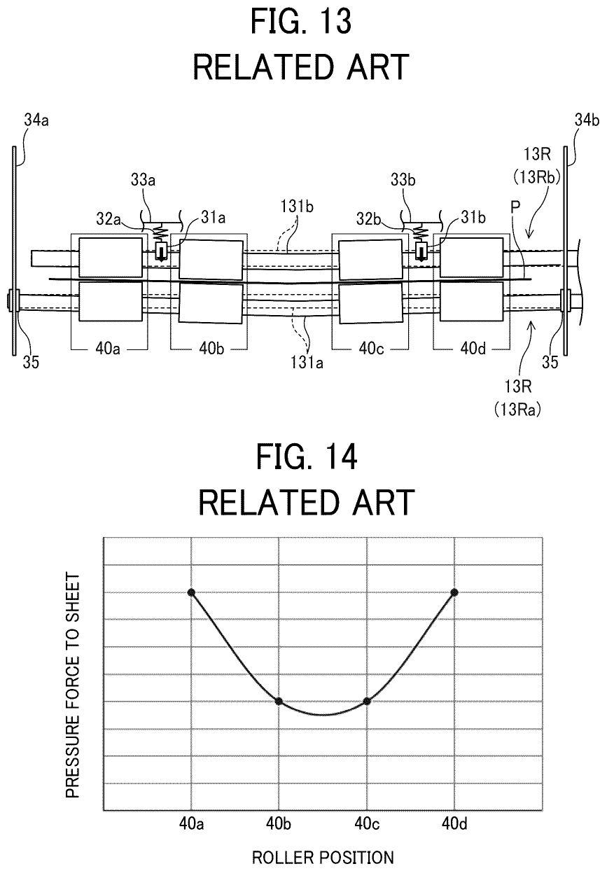

FIG. 13 is a schematic diagram illustrating the shift roller pair 13R according to a related art.

FIG. 14 is a graph of a pressure force applied to a sheet by each conveyance roller pair of a shift roller pair according to a related art.

As illustrated in FIG. 13, the shift roller pair 13R in the related art includes a single driven roller shaft 131b.

The drive roller shaft 131a of a shift drive roller 13Ra supported by double support by the rear side panel 34a and the front side panel 34b via the bearings 35 bends so that the center of the drive roller shaft 131a in the axial direction separates from the shift driven roller 13Rb due to pressure of the shift driven roller 13Rb as indicated by solid lines in FIG. 13.

The driven roller shaft 131b of the shift driven roller 13Rb bends following the bend of the drive roller shaft 131a due to pressure of the rear side pressing member 32a and the front side pressing member 32b from the state indicated by broken lines in FIG. 13. However, since the driven roller shaft 131b is movable within a predetermined range in the pressing direction (the vertical direction) of the pressing members 32a and 32b, the driven roller shaft 131b does not bend in the same manner as the drive roller shaft 131a, and the bending amount of the driven roller shaft 131b is smaller than the bending amount of the drive roller shaft 131a. As a result, as illustrated in FIG. 14, the pressure force applied to the sheet P by the two conveyance roller pairs 40b and 40c at the center in the axial direction is smaller than the pressure force applied to the sheet P by the two conveyance roller pairs 40a and 40d at the axial end portions in the axial direction.

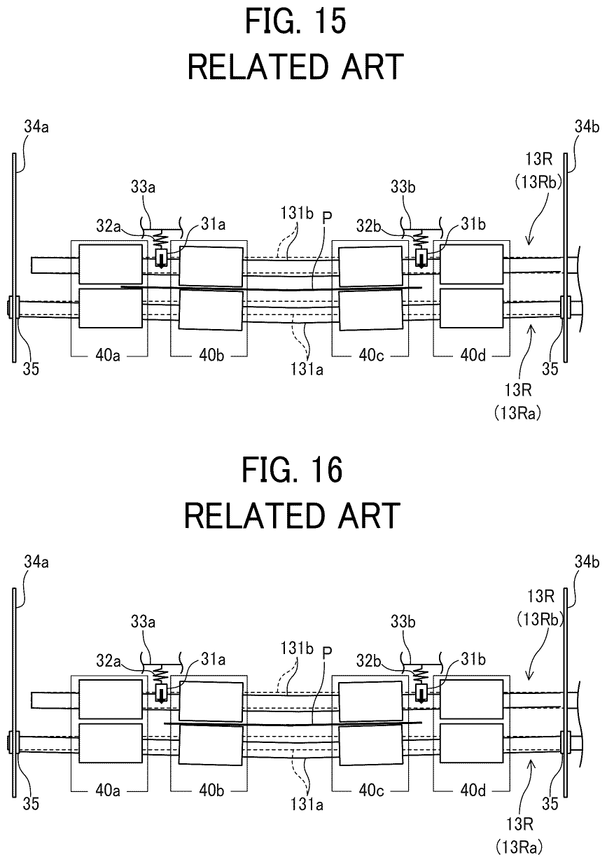

FIG. 15 is a diagram illustrating an example of sheet conveyance by a shift roller pair according to a related art.

FIG. 16 is a diagram illustrating an example of sheet conveyance by a shift roller pair according to a related art.

As illustrated in FIG. 13, when the sheet P is conveyed by the four conveyance roller pairs 40a, 40b, 40c and 40d, the sheet P can be conveyed well. However, as illustrated in FIG. 15, when the sheet P is conveyed while being shifted to the rear side and is nipped by the conveyance roller pairs 40a, 40b and 40c, the conveyance roller pairs 40b and 40c having a smaller pressure force to the sheet P slip with respect to the sheet P, and the sheet may be skewed. Further, as illustrated in FIG. 16, when the sheet P having a narrower width size is conveyed by the conveyance roller pairs 40b and 40c having a smaller contact pressure is conveyed, the conveyance roller pairs 40b and 40c may not be ejected by a given timing due to slip, resulting in a paper jam, or inclination (skew) of a sheet P may occur.

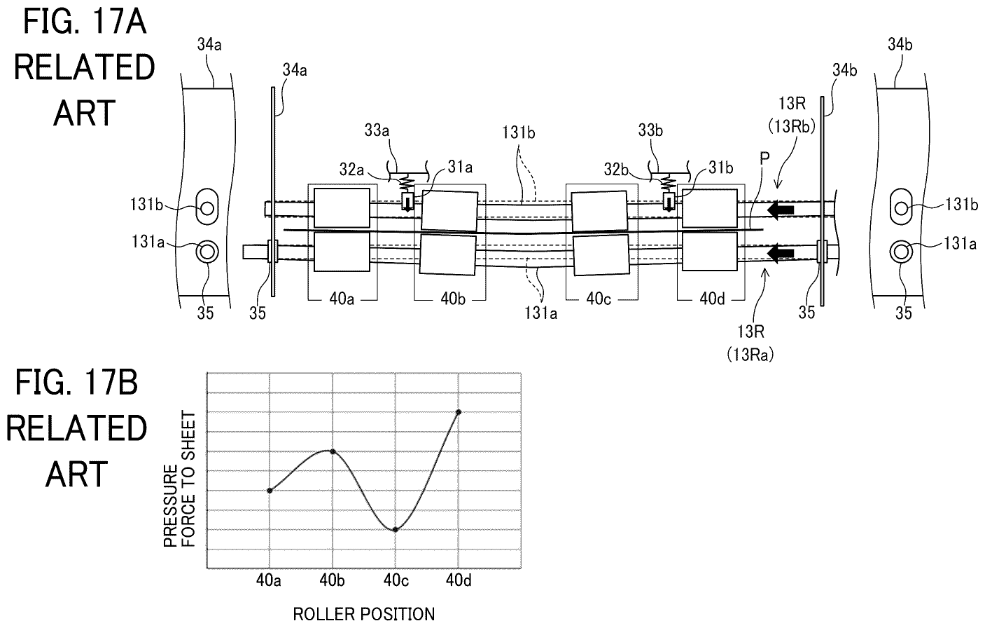

FIG. 17A is a schematic diagram illustrating the shift roller pair 13R according to a related art shifted to the rear side of the inner finisher 100.

FIG. 17B is a graph of a pressure force applied to a sheet by each conveyance roller pair of the shift roller pair 13R according to a related art when shifted to the rear side of the inner finisher 100 of FIG. 17A.

When the shift roller pair 13R in the related art is shifted to the rear side as illustrated in FIG. 17A, a first conveyance roller pair 40a that is a first roller pair from the rear side is separated from the pressing member 32a on the rear side, and a second conveyance roller pair 40b that is a second roller pair from the rear side approaches the pressing member 32a on the rear side. A third conveyance roller pair 40c that is a third roller pair from the rear side is separated from the pressing member 32b on the front side, and a fourth conveyance roller pair 40d that is a fourth roller pair from the rear side approaches the pressing member 32b on the front side. As a result, the pressure force applied to the sheet by each conveyance roller pair is as illustrated in FIG. 17B. Accordingly, it is likely that a sheet P slips on the first conveyance roller pair 40a, the second conveyance roller pair 40b, the third conveyance roller pair 40c and the fourth conveyance roller pair 40d. It is also likely that skew (inclination) of a sheet P occurs when the sheet P is being conveyed by the four conveyance roller pairs, which are the first conveyance roller pair 40a, the second conveyance roller pair 40b, the third conveyance roller pair 40c and the fourth conveyance roller pair 40d.

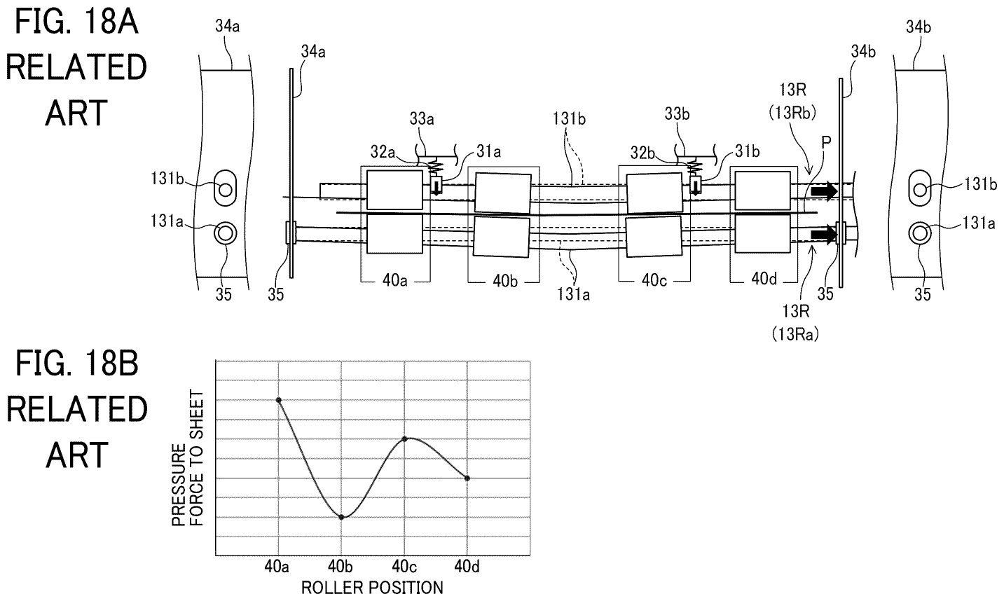

FIG. 18A is a schematic diagram illustrating the shift roller pair 13R according to a related art shifted to the front side of the inner finisher 100.

FIG. 18B is a graph of a contact pressure of each conveyance roller pair when the shift roller pair 13R is on the front side of the inner finisher 100 of FIG. 18A.

As illustrated in FIG. 18A, when the shift roller pair 13R is shifted to the front side, the first conveyance roller pair 40a that is a first roller pair from the rear side approaches the pressing member 32a on the rear side, and the second conveyance roller pair 40b that is a second roller pair from the rear side is separated from the pressing member 32a on the rear side. The third conveyance roller pair 40c that is a third roller pair from the rear side approaches the pressing member 32b on the front side, and the fourth conveyance roller pair 40d that is a fourth roller pair from the rear side is separated from the pressing member 32b on the front side. As a result, the pressure force of each conveyance roller pair to the sheet P is as illustrated in FIG. 18B. Accordingly, when the shift roller pair 13R in the related art is shifted to the front side, it is likely that a sheet P slips on the second conveyance roller pair 40b, the third conveyance roller pair 40c and the fourth conveyance roller pair 40d. It is also likely that skew (inclination) of a sheet P occurs when the sheet P is being conveyed by the four conveyance roller pairs, which are the first conveyance roller pair 40a, the second conveyance roller pair 40b, the third conveyance roller pair 40c and the fourth conveyance roller pair 40d.

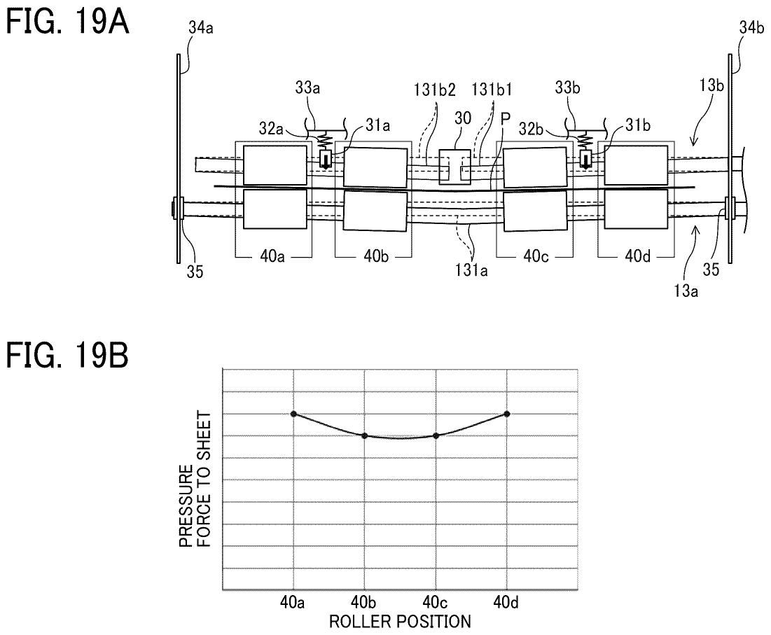

FIG. 19A is a diagram illustrating a shift roller pair 13 according to the present embodiment located at a default position.

FIG. 19B is a graph of the pressure force applied to a sheet by each conveyance roller pair at the default position.

The shift driven roller 13b according to the present embodiment includes a first driven roller shaft 131b1 and a second driven roller shaft 131b2. The first driven roller shaft 131b1 and the second driven roller shaft 131b2 are coupled by a coupling member 30 at the center in the axial direction. The coupling member 30 is movable with respect to the first driven roller shaft 131b1 and the second driven roller shaft 131b2. With this configuration, as illustrated in FIG. 19A, when the drive roller shaft 131a is bent from the broken line to the solid line in FIG. 19A, the first driven roller shaft 131b1 and the second driven roller shaft 131b2 are inclined with respect to the coupling member 30. Accordingly, the first driven roller shaft 131b1 and the second driven roller shaft 131b2 can be made to follow the drive roller shaft 131a, and as illustrated in FIG. 19B, the pressure force of the second conveyance roller pair 40b and the third conveyance roller pair 40c at the center in the axial direction of the shift roller pair 13 to a sheet P can be prevented from decreasing. As a result, a slip on the sheet P by the second conveyance roller pair 40b and the third conveyance roller pair 40c at the center in the axial direction of the shift roller pair 13 can be prevented from occurring.

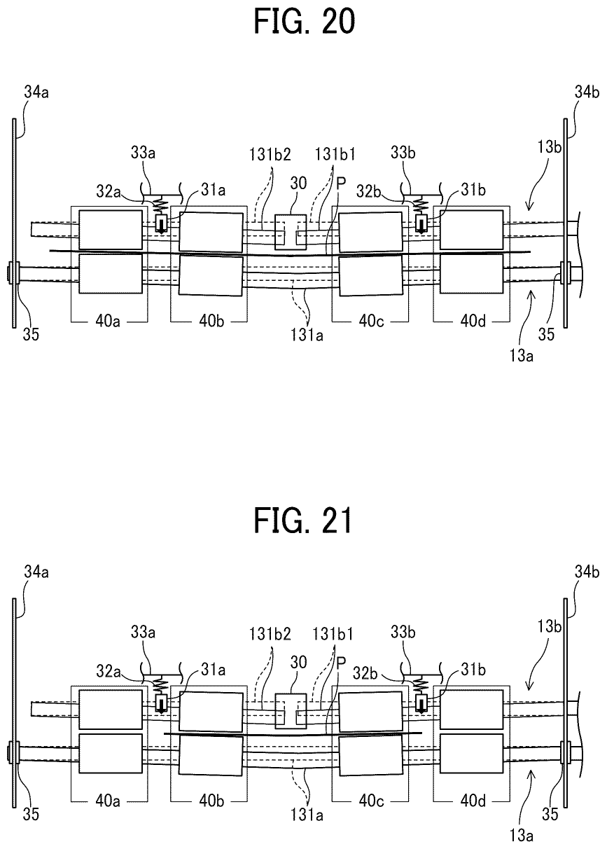

FIG. 20 is a diagram illustrating an example of sheet conveyance by a shift roller pair according to the present embodiment.

FIG. 21 is a diagram illustrating an example of sheet conveyance by a shift roller pair according to the present embodiment.

Accordingly, as illustrated in FIG. 20, a sheet P can be prevented from being inclined (skewed) when the sheet P is shifted to the rear side and conveyed by the first conveyance roller pair 40a, the second conveyance roller pair 40b and the third conveyance roller pair 40c. Since a slip on a sheet P by the second conveyance roller pair 40b and the third conveyance roller pair 40c at the center in the axial direction, as illustrated in FIG. 21, when the sheet P is conveyed by the second conveyance roller pair 40b and the third conveyance roller pair 40c only, occurrence of a paper jam and inclination (skew) of the sheet P can be prevented.

In the present embodiment, the multiple driven conveyance rollers 140b are pressed in and fixed to a driven roller shaft. The driven roller shaft is a rotary shaft that integrally rotates with the driven conveyance rollers 140b. Alternatively, the driven roller shaft may be a fixed shaft and the driven conveyance rollers 140b may be relatively rotatable with respect to the driven roller shaft.

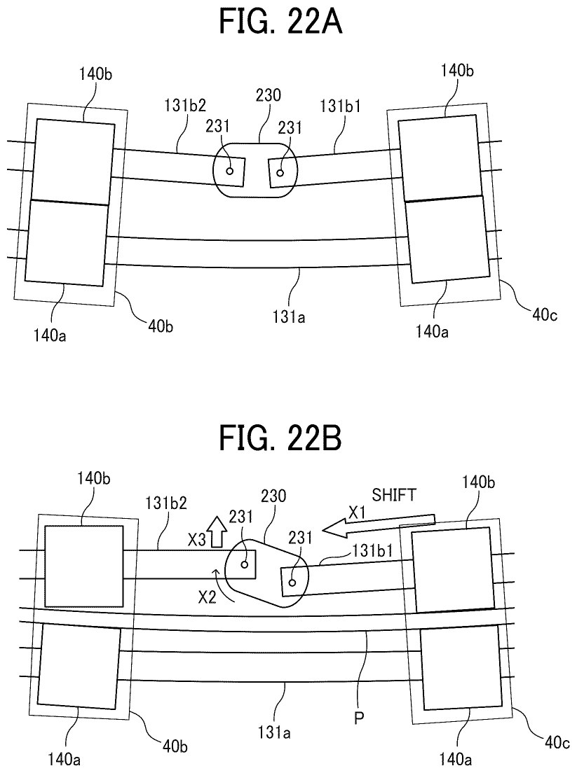

FIGS. 22A and 22B are diagrams each illustrating an example of a configuration in which the rotation of the coupling member 30 is not restricted during a shift operation.

As illustrated in FIG. 22A, the driven roller shafts 131b1 and 131b2 are coupled to a coupling member 230 so as to be rotatable about connection pins 231a and 231b. The coupling member 230 is movable in the vertical direction (upward and downward directions) and is not movable to the sheet conveyance direction (the vertical direction to the drawing sheet).

As illustrated in FIG. 22B, the first driven roller shaft 131b1 is moved to the rear side (in a direction indicated by arrow X1 in the drawing) by the shift mechanism 60 during the shift operation. The movement of the first driven roller shaft 131b1 pushes the coupling member 30 obliquely downward to the left in FIG. 22B. Due to this pushing, the coupling member 30 rotates in a direction indicated by arrow X2 in FIG. 22B against the biasing force of the pressing member 32a, and the coupling portion with the coupling member 30 of the second driven roller shaft 131b2 is moved in the direction away from the shift drive roller 13a (a direction indicated by arrow X3 in FIG. 22B). As a result, the driven conveyance rollers 140b supported by the second driven roller shaft 131b2 is separated from the sheet P, or the pressure force to the sheet P is reduced. Due to such reasons, the sheet P slips with respect to the first conveyance roller pair 40a and the second conveyance roller pair 40b, and the large skew of the sheet P is likely to occur.

In the present embodiment, a restrictor that contacts the coupling member 30 in the shift operation to restrict a rotation of the coupling member 30 is mounted on each of the first driven roller shaft 131b1 and the second driven roller shaft 131b2.

A detailed description is now given of the configuration and operations of the coupling member 30 according to the present embodiment.

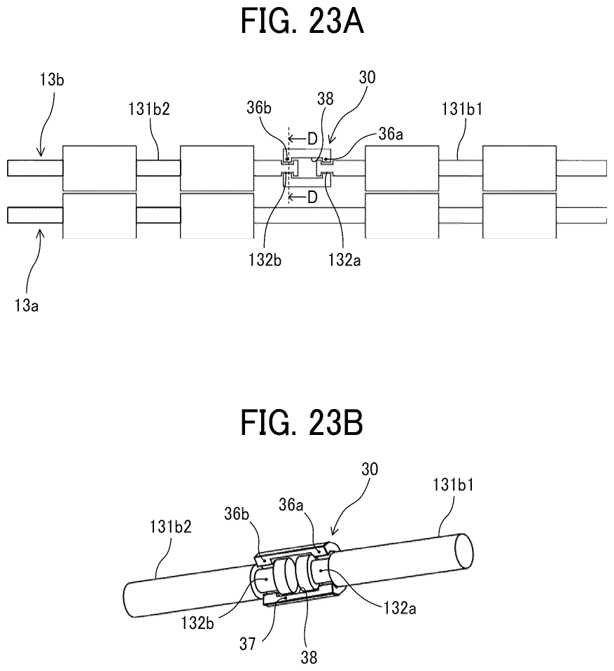

FIGS. 23A and 23B are schematic diagrams each illustrating the shift driven roller 13b in which the first driven roller shaft 131b1 and the second driven roller shaft 131b2 are coupled by the coupling member 30 according to the present embodiment.

The coupling member 30 according to the present embodiment has a C-shaped cross section by cutting out a part of a cylindrical shape having an opening 38 as a cavity that passes through in the axial direction. Engagement projections 36a and 36b each protruding inward are disposed at both axial ends of the coupling member 30 in the axial direction, in other words, axial ends of the coupling member 30. A groove 132a is formed at a rear-side end of the first driven roller shaft 131b1, and a groove 132b is formed at a front-side end of the second driven roller shaft 131b2. The engagement projection 36a of the coupling member 30 is engaged with the groove 132a of the first driven roller shaft 131b1, and the engagement projection 36b of the coupling member 30 is engaged with the groove 132b of the second driven roller shaft 131b2.

As the engagement projections 36a and 36b of the coupling member 30 are engaged with the grooves 132a and 132b of the first driven roller shaft 131b1 and the second driven roller shaft 131b2, the first driven roller shaft 131b1 and the second driven roller shaft 131b2 are prevented from coming off from the coupling member 30 in the axial direction.

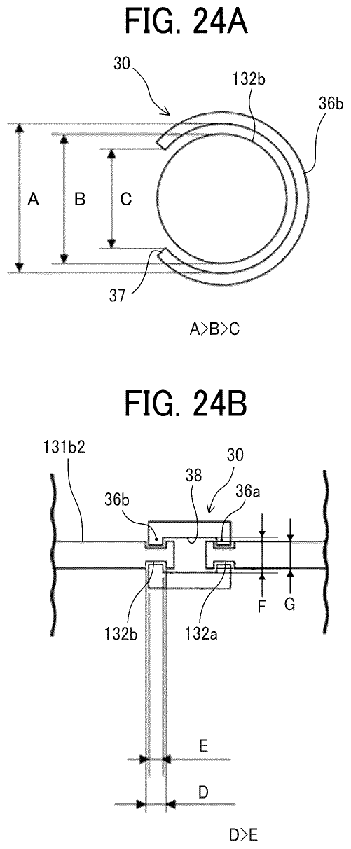

FIGS. 24A and 24B are diagrams each illustrating a relation of dimension of the coupling member 30 and the driven roller shaft, according to the present embodiment.

FIG. 24A is a cross-sectional view taken along line D-D in FIG. 23A.

FIG. 24B is an enlarged view of the coupling member 30 and the vicinity of the coupling member 30 in FIG. 23A.

As illustrated in FIG. 24A, when the width of a cutout portion 37 of the coupling member 30 is “C”, the diameter of the bottom of the groove 132b of the driven roller shaft 131b2 is “B”, and the diameter of the top of the engagement projection 36b is “A”, the relation of A>B>C is satisfied. The relation of dimension of the engagement projection 36a, the groove 132a, and the cutout portion 37 that is partly cut out on the front side is the same as the relation of dimension on the rear side described above.

As illustrated in FIG. 24B, when the width (length in the axial direction) of the groove 132b is “D” and the width (length in the axial direction) of the engagement projection 36b is “E”, the relation of D>E is satisfied. In addition, when the inner diameter of the opening 38 of the coupling member 30 is “F” and the diameter of each of the driven roller shafts 131b1 and 131b2 is “G”, the relation of F>G is satisfied.

As the relations of A>B, D>E, and F>G, the driven roller shafts 131b1 and 131b2 have given gaps in the axial direction and the radial direction with respect to the coupling member 30. As a result, the coupling member 30 can rotate with respect to the driven roller shafts 131b1 and 131b2 within a given range.

Since the driven roller shafts 131b1 and 131b2 have a given gap in the radial direction with respect to the coupling member 30, the driven rollers 131b1 and 131b2 can preferably rotate together with the driven conveyance rollers.

The relations of A>B, D>E, and F>G may be set as appropriate according to the amount of bend of the drive roller shaft 131a. In the present embodiment, when the driven roller shafts 131b1 and 131b2 can be inclined with respect to the coupling member 30 by an angle of 0 degree or more and 5 degrees or less, the driven roller shafts 131b1 and 131b2 can be made to follow the drive roller shaft 131a that is bent. The relation of A and B, the relation of D and E, and the relation of F and G are set so that the angle θ can be inclined by the degree of 0<θ≤5.

Further, since the relation of B>C is satisfied, the driven roller shafts 131b1 and 131b2 are prevented from easily coming off from the cutout portion 37 after being coupled to the coupling member 30.

The coupling member 30 according to the present embodiment is elastically deformable so that the width of the cutout portion 37 is increased, and when the driven roller shafts 131b1 and 131b2 are coupled to the coupling member 30, the end portions of the driven roller shafts are pushed in from the cutout portion 37 of the coupling member 30. As a result, the coupling member 30 is elastically deformed so that the width of the cutout portion 37 is increased, and the end portions of the driven roller shafts 131b1 and 131b2 are pushed into the opening 38 of the coupling member 30, so that the driven roller shafts 131b1 and 131b2 are coupled to the coupling member 30. Accordingly, the driven roller shafts 131b1 and 131b2 can be assembled to the opening 38 of the coupling member 30 only by pushing the end portions of the driven roller shafts 131b1 and 131b2 from the cutout portion 37, and the shift driven roller 13b can be easily assembled. In the present embodiment, as the coupling member 30 is formed of a single member, an increase in the number of components of the shift driven roller 13b can be reduced or prevented, and an increase in the cost of the device can be reduced or prevented.

By setting the difference (B−C) between the diameter B of the bottom of each of the grooves 132a and 132b and the width C of the cutout portion 37 to at least 0.3 mm to several mm (in the present embodiment, about 0.5 mm), the driven roller shafts 131b1 and 131b2 can be prevented from coming off from the cutout portion 37 while obtaining easy assemblability.

Further, by setting the difference between the diameter G of each of the driven roller shafts 131b1 and 131b2 and the diameter A of the top of the engagement projection 36b to at least several mm (in the present embodiment, about 1 mm), the driven roller shafts 131b1 and 131b2 can be prevented from coming off from the coupling member 30 in the axial direction.

Since the driven roller shafts 131b1 and 131b2 preferably rotate with the driven conveyance rollers, each of the driven roller shafts 131b1 and 131b2 has a given gap in the radial direction with respect to the coupling member 30. However, in a case where the driven roller shafts 131b1 and 131b2 are fixed shafts and the driven conveyance rollers rotate relative to the driven roller shafts, the gap may not be provided in the sheet conveyance direction. By eliminating the gap in the sheet conveyance direction between the respective driven roller shafts 131b1 and 131b2 and the coupling member 30, the respective driven roller shafts 131b1 and 131b2 can be prevented from being inclined in the sheet conveyance direction with respect to the coupling member 30. Accordingly, the displacement of the driven conveyance rollers 140b in the sheet conveyance direction can be reduced or prevented, and the decrease in the pressure of the conveyance roller pair to the sheet can be reduced and prevented.

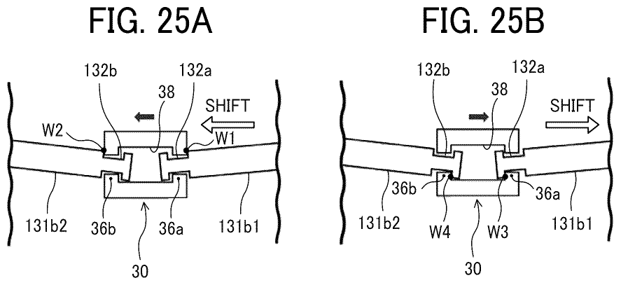

FIG. 25A is a diagram illustrating restriction of rotation of the coupling member 30 when the shift driven roller 13b is shifted to the rear side of the inner finisher 100.

FIG. 25B is a diagram illustrating restriction of rotation of the coupling member 30 when the shift driven roller 13b is shifted to the front side of the inner finisher 100.

As illustrated in FIG. 25A, when the first driven roller shaft 131b1 is moved to the rear side by the shift mechanism 60, the engagement projection 36a of the front end portion of the coupling member 30 contacts the side face of the front side of the groove 132a of the first driven roller shaft 131b1 (“W1” in FIG. 25A). Due to this action, the rotation of the coupling member 30 in the clockwise direction in FIG. 25A is restricted. Then, the side face on the front side of the groove 132a pushes the engagement projection 36a at the end portion on the front side of the coupling member 30 obliquely downward to the left in FIG. 25A. By this pushing, the coupling member 30 moves to the rear side as indicated by an arrow in FIG. 25A. Then, the engagement projection 36b at the rear side end of the coupling member 30 contacts the rear side face of the groove 132b of the second driven roller shaft 131b2 (“W2” in FIG. 25A), and the second driven roller shaft 131b2 is pushed to the rear side. As a result, the second driven roller shaft 131b2 is moved toward the rear side while substantially maintaining the posture as illustrated in FIG. 25A. Accordingly, when the shift operation is performed toward the rear side, each of the driven roller shafts 131b1 and 131b2 can maintain the state of following the drive roller shaft 131a.

As illustrated in FIG. 25B, when the first driven roller shaft 131b1 is moved to the front side by the shift mechanism 60, the engagement projection 36a of the front end portion of the coupling member 30 contacts the side face of the rear side of the groove 132a of the first driven roller shaft 131b1 (“W3” in FIG. 25B). Then, the side face on the rear side of the groove 132a pushes the engagement projection 36a of the coupling member 30 obliquely upward to the right in FIG. 25B. Due to the pushing action, when the coupling member 30 is about to rotate in the counterclockwise direction in FIG. 25B, the engagement projection 36b at the rear end of the coupling member 30 contacts the side face on the front side of the groove 132b of the second driven roller shaft 131b2 (“W4” in FIG. 25B), and the rotation of the coupling member 30 is restricted. As a result, the rear side end of the first driven roller shaft 131b1 is prevented from moving in the direction away from the shift drive roller 13a due to rotation of the coupling member 30 in the counterclockwise direction in FIG. 25B, and the first driven roller shaft 131b1 is moved toward the front side while substantially maintaining the posture illustrated in FIG. 25B.

Further, as the side face on the front side of the groove 132b of the second driven roller shaft 131b2 is moved by the engagement projection 36b at the end portion on the rear side of the coupling member 30, the second driven roller shaft 131b2 is moved to the rear side while substantially maintaining the posture illustrated in FIG. 25B. Accordingly, when the shift operation is performed toward the front side, each of the driven roller shafts 131b1 and 131b2 can maintain the state of following the drive roller shaft 131a.

As described above, in the present embodiment, the side face of each of the grooves 132a and 132b functions as a restrictor that restricts the rotation of the coupling member 30 in the shift operation.

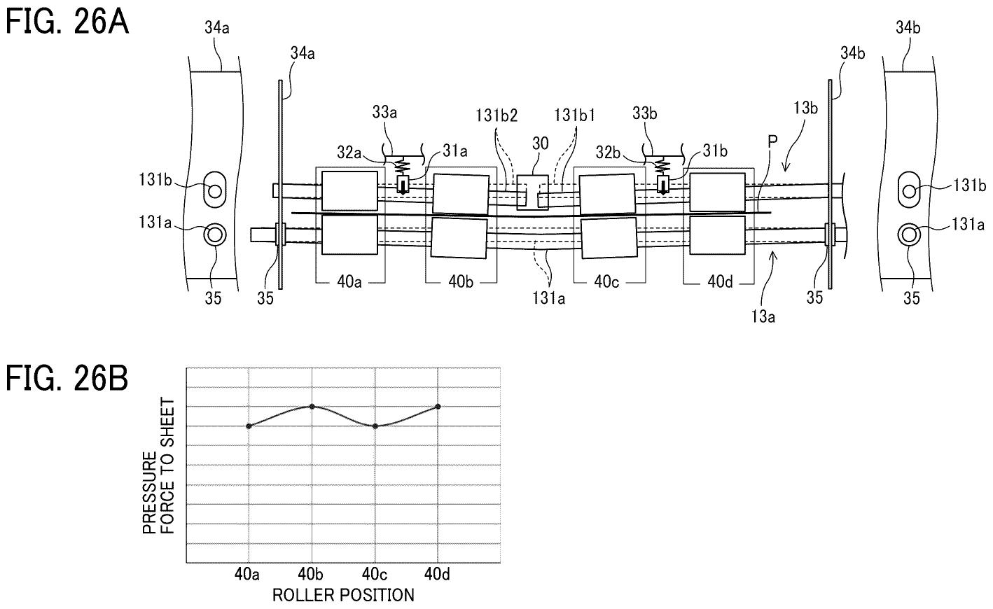

FIG. 26A is a schematic diagram illustrating the shift roller pair 13 according to the present embodiment shifted to the rear side of the inner finisher 100.

FIG. 26B is a graph of the pressure force applied to a sheet by each conveyance roller pair of the shift roller pair 13 according to the present embodiment when shifted to the rear side of the inner finisher 100 of FIG. 26A.

Rotation of the coupling member 30 when the shift roller pair 13 is shifted to the rear side is restricted by the side faces of the grooves 132a and 132b each as a restrictor. Accordingly, the first driven roller shaft 131b1 and the second driven roller shaft 131b2 can maintain the state following the drive roller shaft 131a without substantially changing the postures of the first driven roller shaft 131b1 and the second driven roller shaft 131b2. Accordingly, as illustrated in FIG. 26B, the pressure force applied to the sheet by each of the conveyance roller pairs 40a, 40b, 40c and 40d can be maintained. Accordingly, a slip on the sheet P by each of the conveyance roller pairs 40a, 40b, 40c and 40d, and the inclination (skew) of the sheet P can be prevented.

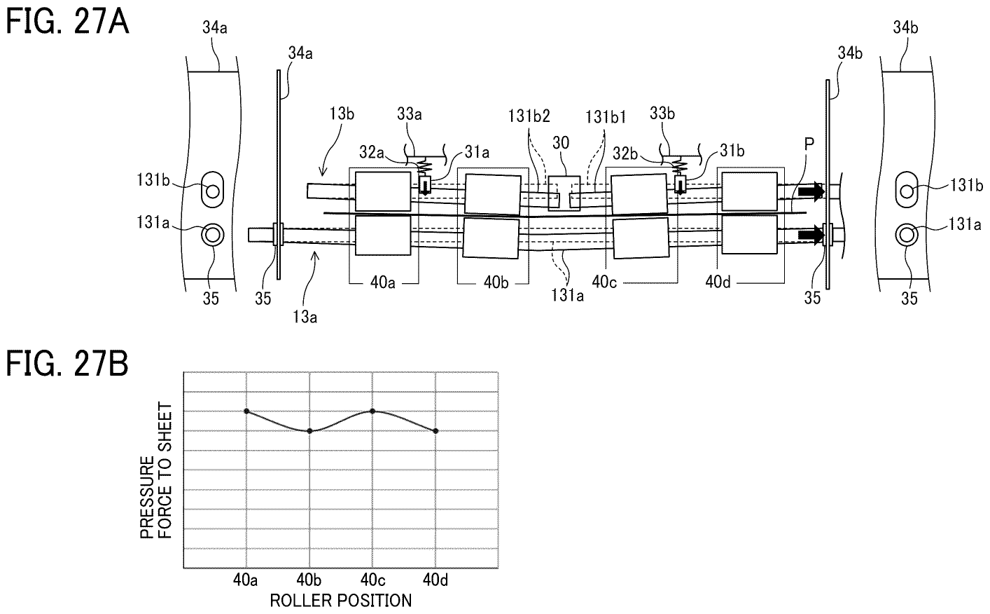

FIG. 27A is a schematic diagram illustrating the shift roller pair 13 according to the present embodiment when shifted to the front side of the inner finisher 100.

FIG. 26B is a graph of the pressure force applied to the sheet by each of the conveyance roller pairs 40a, 40b, 40c and 40d of the shift roller pair 13 according to the present embodiment when shifted to the front side of the inner finisher 100 of FIG. 27A.

As illustrated in FIG. 27A, when the shift roller pair 13 is shifted to the front side, rotation of the coupling member 30 is restricted by the side faces of the grooves 132a and 132b each as a restrictor. Accordingly, the first driven roller shaft 131b1 and the second driven roller shaft 131b2 can maintain the state following the drive roller shaft 131a without substantially changing the postures of the first driven roller shaft 131b1 and the second driven roller shaft 131b2. Accordingly, as illustrated in FIG. 27B, the pressure force applied to the sheet by each of the conveyance roller pairs 40a, 40b, 40c and 40d can be maintained. Accordingly, a slip on the sheet P by each of the conveyance roller pairs 40a, 40b, 40c and 40d, and the inclination (skew) of the sheet P can be prevented.

### First Modification

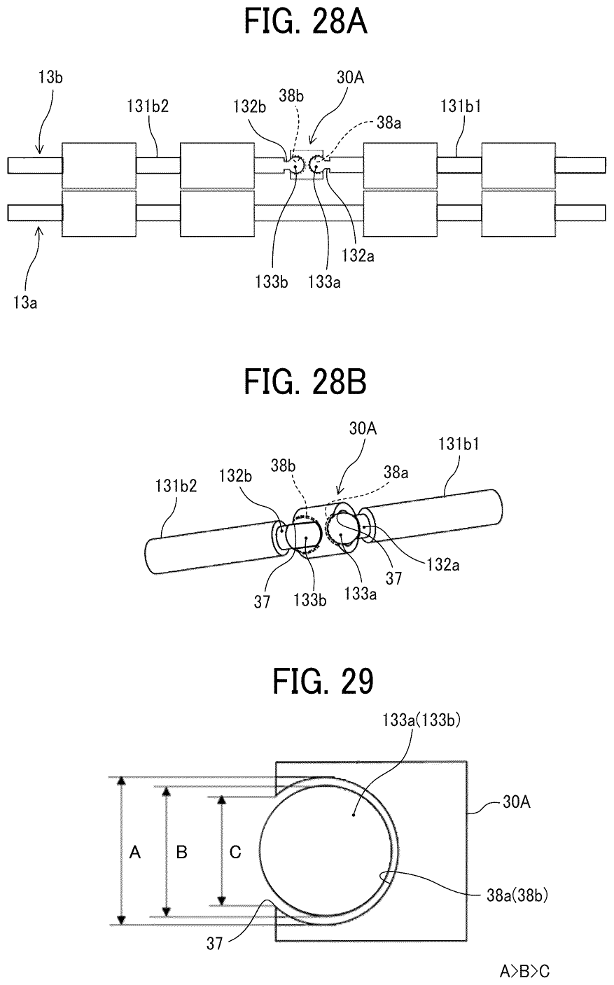

FIGS. 28A and 28B are schematic diagrams each illustrating a shift roller pair according to a first modification.

As illustrated in FIGS. 28A and 28B, the first driven roller shaft 131b1 and the second driven roller shaft 131b2 are coupled by a coupling member 30A according to the first modification. The end portion on the rear side of the first driven roller shaft 131b1 is a spherical end 133a, and the end portion on the front side of the second driven roller shaft 131b2 is a spherical end 133b. The coupling member 30A has cavity portions 38a and 38b (such as openings or holes) in the inner peripheral face on both axial ends in the axial direction. The spherical end 133a of the first driven roller shaft 131b1 is engaged with the cavity portion 38a of the coupling member 30A, and the spherical end 133b of the second driven roller shaft 131b2 is engaged with the cavity portion 38b of the coupling member 30A. By so doing, the first driven roller shaft 131b1 and the second driven roller shaft 131b2 are coupled via the coupling member 30A. Each of the cavity portions 38a and 38b of the coupling member 30A has a cutout portion 37 that is partly cut out.

FIG. 29 is a diagram illustrating the relation of the dimension of the shift roller pair 13 according to the first modification.

When the width of the cutout portion 37 of the coupling member 30A is “C”, the diameter of each of the spherical ends 133a and 133b of the driven roller shafts 131b1 and 131b2 is “B”, and the diameter of each of the cavity portions 38a and 38b of the coupling member 30A is “A”, the relation of A>B>C is satisfied. By setting the relation of A>B, a gap is formed between the cavity portion 38a (or 38b) of the coupling member 30A and the spherical end 133a (or 133b). As a result, the coupling member 30A can smoothly rotate with respect to the driven roller shafts 131b1 and 131b2 within a given range. Further, the driven roller shafts 131b1 and 131b2 can preferably be rotated with the driven conveyance rollers.

Further, since the relation of B>C is satisfied, the spherical ends 133a and 133b are prevented from easily coming off from the cutout portion 37.

As in the present embodiment, the coupling member 30A of the first modification is elastically deformable so as to increase the width of the cutout portion 37. When the spherical ends 133a and 133b are fitted into the cavity portions 38a and 38b, respectively, the spherical ends 133a and 133b are pushed in from the cutout portion 37 of the coupling member 30A. As a result, the coupling member 30A is elastically deformed so as to increase the width of the cutout portion 37, the spherical ends 133a and 133b are pushed into the cavity portions 38a and 38b, respectively, and the spherical ends 133a and 133b are fitted into the cavity portions 38a and 38b, respectively. The difference between the diameter B of each of the spherical ends 133a and 133b and the width C of the cutout portion 37 (B−C) is set to at least 0.3 mm to several mm (about 0.5 mm in the present embodiment), so that the spherical ends 133a and 133b can be prevented from easily coming off from the cutout portion 37 while maintaining easy assemblability. Further, even in such a configuration, the first driven roller shaft 131b1 and the second driven roller shaft 131b2 can be coupled by the coupling member as a single component, and prevent an increase in the number of parts and components, so as to achieve the cost reduction of the device.

In the first modification, the end portions of the driven roller shafts 131b1 and 131b2 to be assembled to the coupling member 30A have a spherical shape, and the cavity portions 38a and 38b of the coupling member 30A to which the end portions of the driven roller shafts 131b1 and 131b2 are assembled have a spherical surface. Accordingly, the driven roller shafts 131b1 and 131b2 can be smoothly inclined with respect to the coupling member 30A. Accordingly, the driven roller shafts 131b1 and 131b2 can be preferably followed to the drive roller shaft 131a that is bent, and a decrease of the pressure force of the conveyance roller pairs 40b and 40c on the center in the axial direction can be preferably prevented.

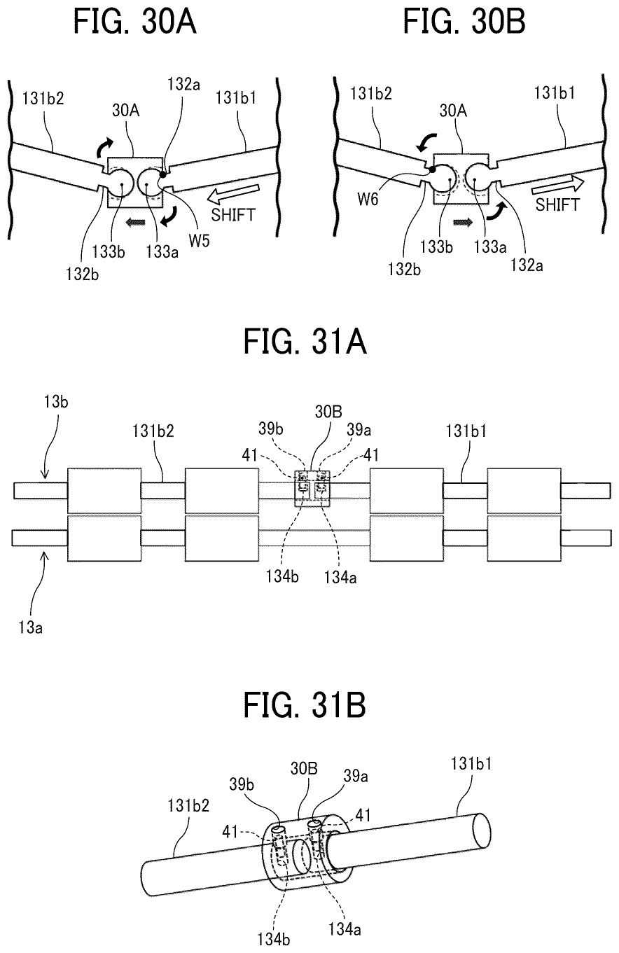

FIG. 30A is a diagram illustrating restriction of rotation of the coupling member 30A when the shift driven roller 13b is shifted to the rear side of the inner finisher 100, according to the first modification.

FIG. 30B is a diagram illustrating restriction of rotation of the coupling member 30A when the shift driven roller 13b is shifted to the front side of the inner finisher 100, according to the first modification.

As illustrated in FIG. 30A, when the first driven roller shaft 131b1 is moved to the rear side of the inner finisher 100 by the shift mechanism 60, the spherical end 133a of the first driven roller shaft 131b1 pushes the coupling member 30A obliquely downward to the left in FIG. 30A. As the coupling member 30A rotates in the clockwise direction in FIG. 30A due to the pushing action, the end portion on the front side of the coupling member 30A contacts the bottom of the groove 132a of the first driven roller shaft 131b1 (see “W5” in FIG. 30A). Due to this contact, the bottom of the groove 132a of the first driven roller shaft 131b1 is pushed toward the shift drive roller 13a. The shift driven roller 13b is supported by the shift drive roller 13a supported by the rear side panel 34a and the front side panel 34b so as not to move in the vertical direction. Accordingly, the movement of the end portion of the rear side of the first driven roller shaft 131b1 to the shift drive roller 13a from the state where the first driven roller shaft 131b1 follows the drive roller shaft 131a is prevented by the rigidity of the shift drive roller 13a. Accordingly, even when the end portion on the front side of the coupling member 30A contacts the bottom of the groove 132a of the first driven roller shaft 131b1 and the end portion on the rear side of the first driven roller shaft 131b1 is pushed to the shift drive roller 13a, the end portion on the rear side of the first driven roller shaft 131b1 does not move to the shift drive roller 13a. As a result, rotation of the coupling member 30A in the clockwise direction in FIG. 30A is restricted. As a result, the driven roller shafts 131b1 and 131b2 can be moved to the rear side while substantially maintaining the posture illustrated in FIG. 30A. Accordingly, when the shift operation is performed toward the rear side, each of the driven roller shafts 131b1 and 131b2 can maintain the state of following the drive roller shaft 131a.

As illustrated in FIG. 30B, when the first driven roller shaft 131b1 is moved to the front side of the inner finisher 100 by the shift mechanism 60, the spherical end 133a of the first driven roller shaft 131b1 pushes the coupling member 30A obliquely upward to the right in FIG. 30A. As the coupling member 30A rotates in the counterclockwise direction in FIG. 30A due to the pushing action, the end portion on the rear side of the coupling member 30A contacts the bottom of the groove 132b of the second driven roller shaft 131b2 (see “W6” in FIG. 30B). Due to the reason similar to the description with FIG. 30A, rotation of the coupling member 30A in the counterclockwise direction in FIG. 30A is restricted. As a result, the first driven roller shaft 131b1 and the second driven roller shaft 131b2 are moved toward the front side while substantially maintaining the posture as illustrated in FIG. 30B. Accordingly, when the shift operation is performed toward the front side, each of the driven roller shafts 131b1 and 131b2 can maintain the state of following the drive roller shaft 131a.

In the first modification, the bottom of each of the grooves 132a and 132b functions as a restrictor to restricts rotation of the coupling member 30A in the shift operation. The widths (the lengths in the axial direction) of the grooves 132a and 132b may be narrowed to cause the coupling member 30A to contact the side faces of the grooves 132a and 132b when the coupling member 30A rotates, so that the side face of the grooves 132a and 132b may restrict the rotation of the coupling member 30A in the shift operation.

### Second Modification

FIGS. 31A and 31B are schematic diagrams each illustrating a shift roller pair according to a second modification.

A coupling member 30B in the second modification has a cylindrical shape, and is provided with through holes 39a and 39b through which the engagement pin 41 penetrates between the rear side and the front side of the inner finisher 100. An engagement hole 134a with which the engagement pin 41 is engaged is formed at the end portion on the rear side of the first driven roller shaft 131b1, and an engagement hole 134b with which the engagement pin 41 is engaged is formed at the end portion on the front side of the second driven roller shaft 131b2.

The end portion on the rear side of the first driven roller shaft 131b1 and the end portion on the front side of the second driven roller shaft 131b2 are inserted into an insertion hole 42 of the coupling member 30B. Then, the engagement pin 41 is inserted through the engagement holes 134a and 134b, so that the tip portion of the engagement pin 41 is inserted into the engagement holes 134a and 134b of the driven roller shafts 131b1 and 131b2, respectively. By so doing, the first driven roller shaft 131b1 and the second driven roller shaft 131b2 are coupled by the coupling member 30B.

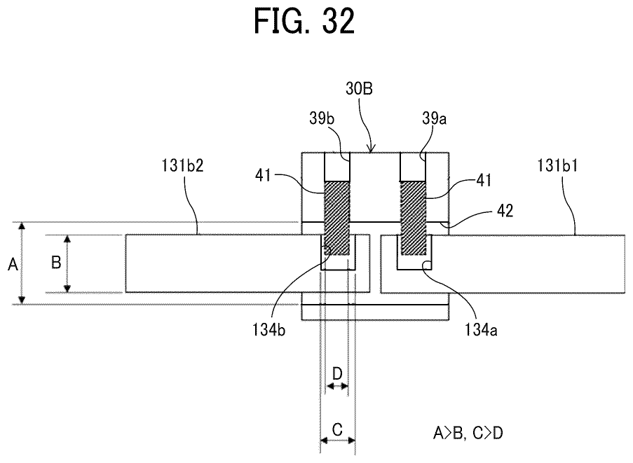

FIG. 32 is a diagram illustrating a relation of a dimension of the shift roller pair according to the second modification.

When the diameter (inner diameter) of the insertion hole of the coupling member 30B is “A” and the diameter of each of the driven roller shafts 131b1 and 131b2 is “B”, the relation of A>B is satisfied. Further, when the diameter (inner diameter) of each of the engagement holes 134a and 134b is “C” and the diameter of the engagement pin 41 is “D”, the relation of C>D is satisfied. Due to this relation, a gap is formed between each of the driven roller shaft 131b1 and 131b2 and the insertion hole 42, and another gap is formed between the engagement pin 41 and each of the engagement hole 134a and 134b. As a result, the coupling member 30B can rotate with respect to the driven roller shafts 131b1 and 131b2 within a given range.

Each of the engagement holes 134a and 134b may be formed in an elongated hole shape extending in the axial direction, and the lengths of the engagement holes 134a and 134b in the sheet conveyance direction (the direction perpendicular to the drawing sheet in FIG. 32) may be substantially equal to the diameters of the engagement pin 41. Due to such a configuration, the driven roller shafts 131b1 and 131b2 are prevented from being inclined in the sheet conveyance direction to the coupling member 30B.

In the second modification, the processing of the driven roller shafts 131b1 and 131b2 is only the hole processing for forming the engagement holes, and the processing range of the driven roller shafts 131b1 and 131b2 can be reduced as compared with the embodiment and the first modification.

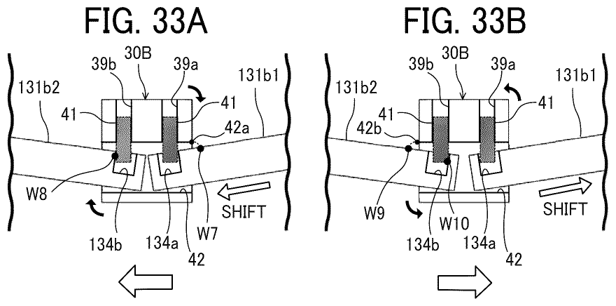

FIG. 33A is a diagram illustrating restriction of rotation of the coupling member 30B when the shift driven roller 13b is shifted to the rear side of the inner finisher 100, according to the second modification.

FIG. 33B is a diagram illustrating restriction of rotation of the coupling member 30B when the shift driven roller 13b is shifted to the front side of the inner finisher 100, according to the second modification.

As illustrated in FIG. 33A, when the first driven roller shaft 131b1 is moved to the rear side of the inner finisher 100 by the shift mechanism 60, the end portion on the front side of the engagement hole 134a of the first driven roller shaft 131b1 contacts an engagement pin 41, so as to push the tip portion of the engagement pin 41 obliquely downward to the left in FIG. 33A. By this pushing, the engagement pin 41 tends to fall toward the front side, and as a result, the coupling member 30B rotates in the clockwise direction in FIG. 33A. In response to this rotation, as a front side end 42a of the insertion hole 42 of the coupling member 30B contacts the outer peripheral face of the first driven roller shaft 131b1 (see “W7” in FIG. 33A), rotation of the coupling member 30B is restricted. Further, due to the rotation of the coupling member 30B in the clockwise direction, the tip end of the engagement pin 41 that is engaged with the engagement hole 134b of the second driven roller shaft 131b2 contacts the inner peripheral face of the engagement hole 134b (see “W8” in FIG. 33A). This contact can also restrict the rotation of the coupling member 30B to some extent.

As a result, the second driven roller shaft 131b2 can be moved to the rear side without substantially rotating the coupling member 30B, so that the second driven roller shaft 131b2 can be moved while substantially maintaining the posture illustrated in FIG. 33A. Accordingly, when the shift operation is performed toward the rear side, each of the driven roller shafts 131b1 and 131b2 can maintain the state of following the drive roller shaft 131a.

As illustrated in FIG. 33B, when the first driven roller shaft 131b1 is moved to the front side of the inner finisher 100 by the shift mechanism 60, the end portion on the rear side of the engagement hole 134a of the first driven roller shaft 131b1 contacts the engagement pin 41, so as to push the engagement pin 41 obliquely upward to the right in FIG. 33B. By this pushing, the engagement pin 41 tends to fall toward the rear side, and as a result, the coupling member 30B rotates in the counterclockwise direction in FIG. 33B. As the coupling member 30B rotates in the counterclockwise direction in FIG. 33B due to the pushing action, the rear side end 42b of the insertion hole 42 of the coupling member 30B contacts the outer peripheral face of the second driven roller shaft 131b2 (see “W9” in FIG. 33B). Due to this action, the rotation of the coupling member 30 in the counterclockwise direction in FIG. 33B is restricted. Further, due to the rotation of the coupling member 30B in the counterclockwise direction, the tip end of the engagement pin 41 that is engaged with the engagement hole 134b of the second driven roller shaft 131b2 contacts the inner peripheral face of the engagement hole 134b (see “W10” in FIG. 33B). This contact can also restrict the rotation of the coupling member 30B to some extent.

As a result, the first driven roller shaft 131b1 can be moved to the front side without substantially rotating the coupling member 30B, so that the first driven roller shaft 131b1 can be moved to the front side while substantially maintaining the posture illustrated in FIG. 33B. Accordingly, when the shift operation is performed toward the front side, each of the driven roller shafts 131b1 and 131b2 can maintain the state of following the drive roller shaft 131a.

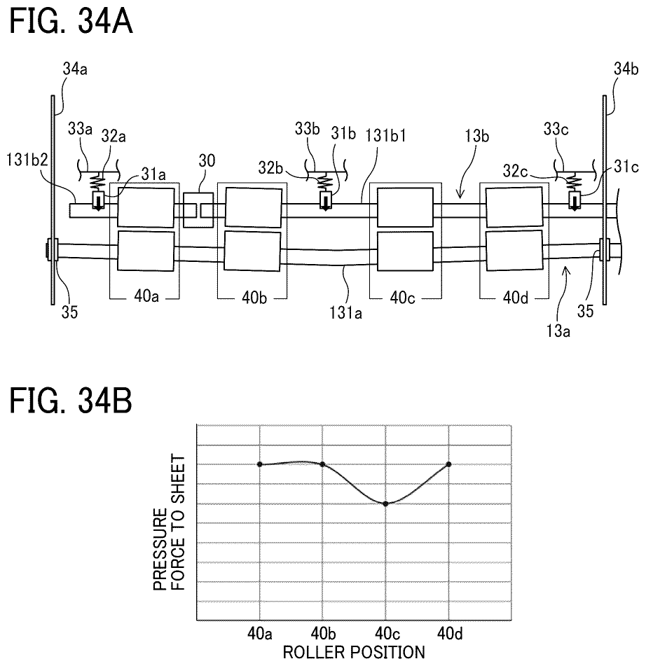

FIG. 34A is a schematic diagram illustrating an example of a coupling member disposed between a first conveyance roller pair and a second conveyance roller adjacent to the first conveyance roller pair on the rear side of an inner finisher.

FIG. 34B is a graph of a pressure force applied to a sheet by each conveyance roller pair of a shift roller pair in the example of FIG. 34A.

In the above description, the first driven roller shaft 131b1 and the second driven roller shaft 131b2 are coupled by the coupling member at the center in the axial direction. However, as illustrated in FIG. 34A, the first driven roller shaft 131b1 and the second driven roller shaft 131b2 may be coupled by the coupling member between the first conveyance roller pair 40a that is a first roller pair from the rear side and the second conveyance roller pair 40b that is a second roller pair from the rear side.

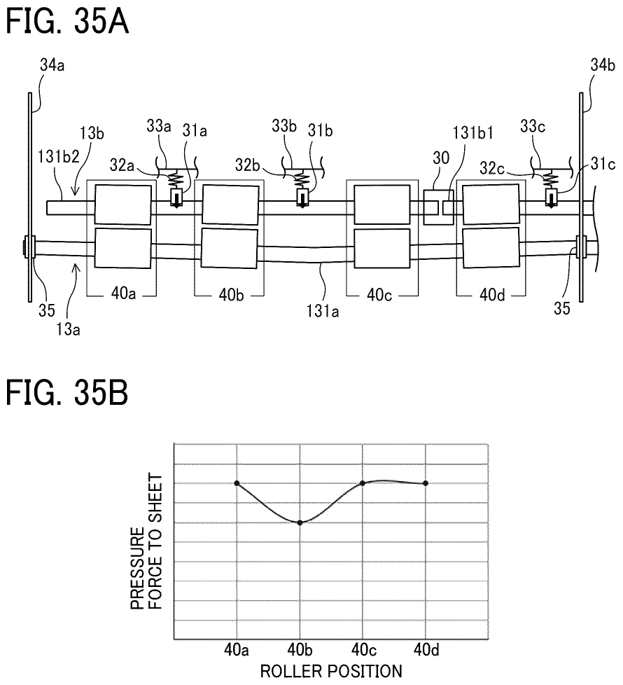

Further, FIG. 35A is a schematic diagram illustrating an example of a coupling member disposed between a first conveyance roller pair and a second conveyance roller adjacent to the first conveyance roller pair on the front side of an inner finisher.

FIG. 35B is a graph of a pressure force applied to a sheet by each conveyance roller pair of a shift roller pair in the example of FIG. 35A.

As illustrated in FIG. 35A, the first driven roller shaft 131b1 and the second driven roller shaft 131b2 may be coupled by the coupling member between the fourth conveyance roller pair 40d that is a first roller pair from the front side and the third conveyance roller pair 40c that is a second roller pair from the front side.

Even when the first driven roller shaft 131b1 and the second driven roller shaft 131b2 are coupled by the coupling member as illustrated in FIGS. 34A and 35A, the first driven roller shaft 131b1 and the second driven roller shaft 131b2 are respectively inclined to the coupling member, which can follow the driven roller shaft that is bent. Accordingly, as illustrated in FIGS. 34B and 35B, a reduction in the pressing force, to the sheet, of the second conveyance roller pair 40b and the third conveyance roller pair 40c both close to the center in the axial direction can be prevented.

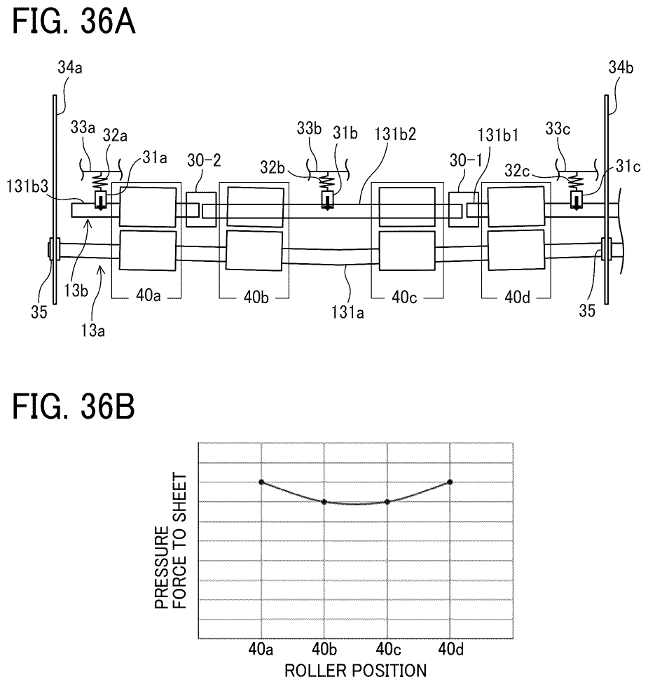

FIG. 36A is a schematic diagram illustrating an example of a shift driven roller that includes three driven roller shafts.

FIG. 36B is a graph of a pressure force applied to a sheet by each conveyance roller pair of a shift roller pair in the example of FIG. 36A.

As illustrated in FIG. 36A, the shift driven roller 13b may include a first driven roller shaft 131b1, a second driven roller shaft 131b2 and a third driven roller shaft 131b3. The first driven roller shaft 131b1 and the second driven roller shaft 131b2 may be coupled by a first coupling member 30-1, and the second driven roller shaft 131b2 and the third driven roller shaft 131b3 may be coupled by a second coupling member 30-2. The first driven roller shaft 131b1 and the second driven roller shaft 131b2 are inclined to the first coupling member 30-1 and the second driven roller shaft 131b2 and the third driven roller shaft 131b3 are inclined to the second coupling member 30-2, which can follow the drive roller shaft 131a that is bent. Accordingly, as illustrated in FIG. 36B, a reduction in the pressing force of the conveyance roller pairs 40b and 40c closed to the axial center to a sheet can be prevented.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. For example, in the above description, the shift driven roller 13b is disposed above the shift drive roller 13a. Alternatively, the shift driven roller 13b may be disposed below the shift drive roller 13a. Even with the above-described configuration, the driven roller shafts 131b1 and 131b2 is inclined to the coupling member 30 due to the pressure force of each of the pressing members 32a and 32b to press the shift driven roller 13b to the shift drive roller 13a, so that the driven roller shafts 131b1 and 131b2 can follow the bend of the roller shaft. Accordingly, a reduction in the pressure force of each of the conveyance roller pairs to a sheet can be prevented.

The embodiments described above are just examples, and the various aspects of the present disclosure attain respective effects as follows.

### Aspect 1

In Aspect 1, a sheet conveying device includes a conveyance roller pair to convey a sheet such as the sheet P, and the conveyance roller pair is the shift roller pair 13 that is movable in the width direction that is a direction orthogonal to the sheet conveyance direction. The sheet conveying device further includes a shift unit that is the shift mechanism 60 to perform a sheet operation in which the shift roller pair 13 is moved in the width direction to shift a sheet in the width direction, in a sheet conveyance by the shift roller pair 13. One shift roller such as the shift driven roller 13b of the shift roller pair 13 includes multiple roller shafts (131b1, 131b2), and is provided with a coupling member 30 that is rotatable around the multiple roller shaft.

When the roller shaft of the other shift roller of the shift roller pair is bent, the roller shaft of the one shift roller does not follow the bending of the roller shaft of the other shift roller, and the contact pressure of the conveyance roller on the axial center in the axial direction of the multiple conveyance rollers of the one shift roller to the sheet becomes lower than the contact pressure of the conveyance roller on the axial end in the axial direction with respect to the sheet. As a result, the conveyance roller on the axial center in the axial direction slips with respect to the sheet, and it was likely that an inclination (skew) occurs to the sheet.

In contrast, in Aspect 1, the one shift roller of the shift roller pair includes multiple roller shafts, and a coupling member that is movable to couple the multiple roller shafts. With this configuration, when the roller shaft of the other shift roller is bent, each of the multiple roller shafts of the one shift roller is inclined to the coupling member, so as to follow the bending of the roller shaft of the other shift roller. Accordingly, the contact pressures of the multiple conveyance rollers in contact with the sheet can be made equal, and the skew of the sheet can be prevented.

### Aspect 2

In Aspect 2, in the sheet conveying device according to Aspect 1, the roller shaft (131b1, 131b2) of the one shift roller includes a restrictor (the side faces of the grooves 132a and 132b in the present embodiment) that contacts the coupling member 30 to restrict rotation of the coupling member 30 in the shift operation.

As illustrated in FIG. 22A, in a case where the coupling member rotates about the connection pins 231a and 231b, in other words, a rotation of the coupling member is not restricted, it is likely that the following inconvenience may occur in the shift operation. In other words, in the shift operation, the roller shaft of the shift roller pair is moved to the other axial end in the axial direction by the shift unit mounted on one axial end of the roller shaft of the shift roller pair in the axial direction. By so doing, the shift roller pair is shifted. Of the shift roller pair, one shift roller has the multiple roller shafts coupled by the coupling member, and the roller shaft on one axial end in the axial direction (as a “roller shaft on one end”) of multiple roller shafts is moved to the other axial end in the axial direction by the shift unit. The roller shaft on the one end is moved toward the other axial end in the axial direction by the shift unit. By so doing, the coupling member is pushed to the other end by the roller shaft on the one end. At this time, if the coupling member is inclined with respect to the roller shaft on the one end, the coupling member rotates due to the pushing of the roller shaft on one end (see FIG. 22B). When the coupling member rotates in the shift operation, it is likely that one of the roller shaft on one end and the roller shaft of the other end coupled to the roller shaft on the one end is moved in a direction away from the sheet and that the conveyance roller supported by the roller shaft is separated from the sheet or the contact pressure to the sheet decreases. As a result, a conveyance failure such as skew of the sheet occurs during in shift operation.

In contrast, in Aspect 2, the coupling member contacts the restrictor in the shift operation, so as to restrict the rotation of the coupling member. Due to such a configuration, the conveyance roller of the one shift roller is prevented from separating from the sheet in the shift operation. Accordingly, a conveyance failure such as sheet skew in the shift operation can be prevented.

### Aspect 3

In Aspect 3, in the sheet conveying device according to Aspect 1 or Aspect 2, each of the end portions of two roller shafts (131b1, 131b2) coupled to the coupling member 30 has a gap, the end portions of the two roller shafts (131b1, 131b2) coupled to the coupling member 30 have at least a gap with respect to the coupling member 30 in a direction orthogonal to any one of the conveyance direction of the sheet such as the sheet P and the axial direction of the roller shaft, and is assembled in the coupling member 30 to be relatively movable in the axial direction to the coupling member 30 within a predetermined range.

According to this configuration, as described in the embodiments above, the coupling member 30 can be rotated in the sheet conveyance direction in a given range. Accordingly, the roller shafts (131b1, 131b2) coupled to the coupling member 30 can be inclined in the direction orthogonal to the coupling member 30, and the roller shafts (131b1, 131b2) can follow the bending of the roller shaft of the other shift roller such as the shift drive roller 13a. Accordingly, among multiple conveyance roller pairs 40a, 40b, 40c and 40d of the shift roller pair, a reduction in the pressure force of the conveyance roller pairs 40b and 40c disposed close to the axial center in the axial direction, to a sheet such as a paper can be restricted, and can restrict a slip on the sheet and the inclination (skew) can be decreased.

### Aspect 4

In Aspect 4, in the sheet conveying device according to any one of Aspects 1 to 3, the coupling member 30 has a cylindrical shape with an opening 38 to which each of the end portions of the two roller shafts coupled to the coupling member 30 is assembled. The coupling member 30 includes engagement projections 36a and 36b to engage with the grooves 132a and 132b formed on the end portions of each of the roller shafts to be coupled to the coupling member 30 at both axial end portions in the axial direction of the roller shafts (131b1, 131b2) of the coupling member 30.

According to this configuration, as described in the embodiments above, as the engagement projections 36a and 36b are engaged with the grooves 132a and 132b, respectively, the roller shafts (131b1, 131b2) can be prevented from coming off from the coupling member 30 in the axial direction. Further, in the shift operation, the engagement projections 36a and 36b contact the side faces of the grooves 132a and 132b to restrict the rotation of the coupling member. As described above, the side faces of the grooves 132a and 132b can function as a restrictor.

### Aspect 5

In Aspect 5, in the sheet conveying device according to any one of Aspects 1 to 4, the end portions of two roller shafts (131b1, 131b2) to be coupled to the coupling member 30 has a spherical shape, and cavity portions 38a and 38b each having an inner peripheral face having a spherical shape to which the spherical end portion of the roller shaft is assembled, at both axial ends in the axial direction of the roller shafts of the coupling member 30.

According to this configuration, as described in the first modification, the roller shafts (131b1, 131b2) can be smoothly inclined with respect to the coupling member. Accordingly, each of the two roller shafts can be preferably followed to the roller shaft (131a) of the other shift roller that is bent, and a decrease of the pressure force of the conveyance roller pairs 40b and 40c on the axial center in the axial direction can be preferably prevented.

### Aspect 6

In Aspect 6, in the sheet conveying device according to Aspect 4 or Aspect 5, the hole of the coupling member is partly cut out.

According to this configuration, as described in the embodiment and the first modification, by pushing the end of the roller shaft through the cutout portion 37 of the coupling member 30, the coupling member 30 is elastically deformed so as to increase the width of the cutout portion 37, and the end of the roller shaft can be assembled to the opening 38 of the coupling member 30. Accordingly, the coupling member 30 can be assembled to the opening 38 of the coupling member 30 only by pushing the end portion of the roller shaft from the cutout portion 37 of the coupling member 30, and the roller shafts can be easily assembled to the coupling member 30.

### Aspect 7

In Aspect 7, in the sheet conveying device according to any one of Aspects 1 to 3, an insertion portion such as the insertion hole 42 into which the end of the roller shaft is inserted, and the through holes 39a and 39b through which an engagement member such as an engagement pin passes are disposed on both axial ends in the axial direction of the roller shaft of the coupling member 30, and the engagement holes 134a and 134b to which an engagement member is engaged, on the end of two roller shafts (131b1, 131b2) coupled to the coupling member 30.

According to this configuration, as described in the second modification, the processing executed on the end of each roller shaft for assembling to the coupling member 30 can be only the hole processing, and the processing range for the roller shaft can be reduced as compared with the embodiment and the first modification.

### Aspect 8

In Aspect 8, the sheet conveying device according to any one of Aspects 1 to 7 further includes multiple pressing members 32a and 32b to press the one shift roller such as the shift driven roller 13b against the other shift roller such as the shift drive roller 13a at a given interval in the axial direction of the multiple roller shafts, and the coupling member 30 is disposed between the multiple pressing members.

According to this configuration, the multiple roller shafts can be pressed against the other shift roller by at least one pressing member. Accordingly, the pressure force of the conveyance roller supported by each of the multiple roller shafts to the sheet such as a paper can be set to a given pressure force, a slip of each of the conveyance rollers on the sheet can be prevented, and the inclination (skew) of the sheet can be preferably prevented.

### Aspect 9

In Aspect 9, a sheet processing apparatus includes a sheet conveying unit, and a sheet processing unit to perform a given process on a sheet conveyed by the sheet conveying device. The sheet conveying unit includes the sheet conveying device according to any one of Aspects 1 to 8.

According to this configuration, the image forming apparatus can prevent inclination (skew) of the sheet in a shift operation in which a sheet is shifted in the width direction by a shift roller pair.

### Aspect 10

In Aspect 10, an image forming apparatus includes a sheet conveying unit and an image forming device that performs an image forming operation to form an image on a sheet conveyed by the sheet conveying unit. The sheet conveying unit used for the image forming apparatus is the sheet conveying device according to any one of Aspects 1 to 8.

According to this configuration, the image forming apparatus can prevent inclination (skew) of the sheet in a shift operation in which a sheet is shifted in the width direction by a shift roller pair.

### Aspect 11

In Aspect 11, a sheet conveying device includes a shift roller pair, a shifter, multiple roller shafts, and a coupler. The shift roller pair includes first shift rollers, and second shift rollers facing the first shift rollers. The shift roller pair is conveyable a sheet in a conveyance direction and movable in a width direction orthogonal to the sheet conveyance direction. The shifter moves the shift roller pair in the width direction to shift the sheet in the width direction as a shift operation. The multiple roller shafts support the first shift rollers. The coupler couples the multiple roller shafts and is rotatable with respect to the multiple roller shafts.

### Aspect 12

In Aspect 12, in the sheet conveying device according to Aspect 11, each of the multiple roller shafts of the first shift rollers includes a restrictor to contact the coupler to restrict a rotation of the coupler with respect to the multiple roller shafts.

### Aspect 13

In Aspect 13, in the sheet conveying device according to Aspect 11 or Aspect 12, the multiple roller shafts includes two roller shafts having axial ends, respectively. The coupler couples the two roller shafts at the axial ends of the two roller shafts in an axial direction. The two roller shafts have a gap between the axial ends and the coupler in a radial direction orthogonal to the sheet conveyance direction and the axial direction. The axial ends are relatively movable with respect to the coupler in the axial direction in a given range in the coupler.

### Aspect 14

In Aspect 14, in the sheet conveying device according to any one of Aspects 11 to 13, the multiple roller shafts includes two roller shafts having axial ends, respectively. The two roller shafts have grooves in the axial ends, respectively. The coupler has a cylindrical shape having a cavity accommodating the axial ends of two roller shafts, and an engagement projection to engage with the grooves.

### Aspect 15

In Aspect 15, in the sheet conveying device according to any one of Aspects 11 to 14, the coupler has a cutout to partially open the cylindrical cavity.

### Aspect 16

In Aspect 16, in the sheet conveying device according to Aspect 14 or Aspect 15, the multiple roller shafts include two roller shafts each having a spherical end. The coupler has a spherical cavity in each end of the coupler in an axial direction. The spherical cavity accommodates the spherical end of the each of the two roller shafts.

### Aspect 17

In Aspect 17, in the sheet conveying device according to any one of Aspects 11 to 13, the coupler has an insertion portion into which respective axial ends of two roller shafts are inserted, and a through hole into which an engagement member is inserted, at both ends of the coupler in an axial direction of the two roller shafts, and each of the two roller shafts coupled to the coupler has an engagement opening into which the engagement member engages at respective ends of the two roller shafts coupled to the coupler.

### Aspect 18

In Aspect 18, the sheet conveying device according to any one of Aspects 11 to 17 further includes multiple pressing members to press the first shift rollers against the second shift rollers at a given interval in an axial direction of the multiple roller shafts. The coupler is disposed between the multiple pressing members.

### Aspect 19

In Aspect 19, a sheet processing apparatus includes the sheet conveying device according to any one of Aspects 11 to 18, and a sheet processing device to perform a given process on a sheet conveyed by the sheet conveying device.

### Aspect 20

In Aspect 20, a sheet processing apparatus includes a sheet processing device to perform a given process on a sheet, and the sheet conveying device according to Aspect 11 to convey the sheet on which the given process is performed by the sheet processing device.

### Aspect 21

In Aspect 21, an image forming apparatus includes an image forming device to form an image on a sheet, and the above-described sheet conveying device according to any one of Aspects 11 to 18 to convey the sheet on which the image is formed by the image forming device.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. A sheet conveying device comprising:
a shift roller pair including:
first shift rollers; and
second shift rollers facing the first shift rollers, the shift roller pair:
conveyable a sheet in a sheet conveyance direction; and
movable in a width direction orthogonal to the sheet conveyance direction; and
a shifter to move the shift roller pair in the width direction to shift the sheet in the width direction as a shift operation;
multiple roller shafts supporting the first shift rollers; and
a coupler coupling the multiple roller shafts, the coupler rotatable with respect to the multiple roller shafts.

2. The sheet conveying device according to claim 1,
wherein each of the multiple roller shafts of the first shift rollers includes a restrictor to contact the coupler to restrict a rotation of the coupler with respect to the multiple roller shafts.

3. The sheet conveying device according to claim 1,
wherein the multiple roller shafts includes two roller shafts having axial ends, respectively,
the coupler couples the two roller shafts at the axial ends of the two roller shafts in an axial direction,
the two roller shafts have a gap between the axial ends and the coupler in a radial direction orthogonal to the sheet conveyance direction and the axial direction, and
the axial ends are relatively movable with respect to the coupler in the axial direction in a given range in the coupler.

4. The sheet conveying device according to claim 1,
wherein the multiple roller shafts includes two roller shafts having axial ends, respectively,
the two roller shafts have grooves in the axial ends, respectively, and
the coupler has a cylindrical shape having:
a cavity accommodating the axial ends of two roller shafts; and
an engagement projection to engage with the grooves.

5. The sheet conveying device according to claim 4,
wherein the coupler has a cutout to partially open the cavity.

6. The sheet conveying device according to claim 1,
wherein the multiple roller shafts include two roller shafts each having a spherical end,
the coupler has a spherical cavity in each end of the coupler in an axial direction, and
the spherical cavity accommodates the spherical end of the each of the two roller shafts.

7. The sheet conveying device according to claim 6,
wherein the coupler has a cutout to partially open the spherical cavity.

8. The sheet conveying device according to claim 1,
wherein the coupler has:
an insertion portion into which respective axial ends of two roller shafts are inserted; and
a through hole into which an engagement member is inserted,
at both ends of the coupler in an axial direction of the two roller shafts, and
each of the two roller shafts coupled to the coupler has an engagement opening into which the engagement member engages at respective ends of the two roller shafts coupled to the coupler.

9. The sheet conveying device according to claim 1, further comprising multiple pressing members to press the first shift rollers against the second shift rollers at a given interval in an axial direction of the multiple roller shafts,
wherein the coupler is disposed between the multiple pressing members.

10. A sheet processing apparatus comprising:
the sheet conveying device according to claim 1; and
a sheet processing device to perform a given process on a sheet conveyed by the sheet conveying device.

11. A sheet processing apparatus comprising:
a sheet processing device to perform a given process on a sheet; and
the sheet conveying device according to claim 1 to convey the sheet on which the given process is performed by the sheet processing device.

12. An image forming apparatus comprising:
an image forming device to form an image on a sheet; and
the sheet conveying device according to claim 1 to convey the sheet on which the image is formed by the image forming device.
